(19) United States
(12) Patent Application Publication
(10) Pub. No.: US 2009/0276205 A1
(43) Pub. Date: Nov. 5, 2009

(54) STABLIZING OPERATION OF AN EMULATED SYSTEM

(76) Inventors: Andrew T. Jennings, Minneapolis, MN (US); Michael J. Rieschl, St. Paul, MN (US); David W. Schroth, Minneapolis, MN (US)

Correspondence Address: UNISYS CORPORATION, Unisys Way, Mail Station E8-114, Blue Bell, PA, 19424, US

(21) Appl. No.: 12/114,233

(22) Filed: May 2, 2008

(51) Int. Cl. G06F 9/455

(52) U.S. Cl. 703/26

(57) ABSTRACT

Disclosure of approaches for stabilizing an emulated system. In one approach, a first operating system (OS) is executed on an instruction processor, the first OS including instructions native to the instruction processor. A second OS and a plurality of application programs are emulated on the first OS. The second OS polls the first OS for memory statistics of the first OS. The memory statistics indicate a current state of operating parameters of the memory of the data processing system used by the first OS in managing the data processing system. The second OS controls a number of the application programs allowed to execute in response to the memory statistics provided by the first OS to the second OS.

### FIELD OF THE INVENTION

The present invention generally relates to maintaining operating stability though monitoring of memory usage and management statistics in an emulated system.

### BACKGROUND OF THE INVENTION

In the past, software applications that require a large degree of data security and recoverability were traditionally supported by mainframe data processing systems. Such software applications may include those associated with utility, transportation, finance, government, and military installations and infrastructures. Such applications were generally supported by mainframe systems because mainframes provide a large degree of data redundancy, enhanced data recoverability features, and sophisticated data security features.

As smaller “off-the-shelf” commodity data processing systems such as personal computers (PCs) have increased in processing power, there has been some movement towards using such systems to support industries that historically employed mainframes for their data processing needs. For instance, one or more personal computers may be interconnected to provide access to “legacy” data that was previously stored and maintained using a mainframe system. Going forward, the personal computers may be used to also update this legacy data, which may comprise records from any of the aforementioned sensitive types of applications. This scenario presents several challenges, as follows.

Some commodity-type operating systems (“commodity OSs”) that are generally available on commodity-type hardware platforms lack the stability needed for non-stop applications. For example, applications such as airline reservation systems and banking systems may require non-stop availability. However, some commodity OSs are prone to failures that result in having to reboot the system. In one instance, defects in the functions of the OS that manage memory allocation and de-allocation are likely the cause. The reasons for the instability of commodity OSs may be traced to their lineage. Since some commodity OSs were initially targeted toward home and personal use, less emphasis may have been placed on system stability and occasional reboots may have been acceptable.

Commodity OSs also may not include the security and protection mechanisms needed to ensure that legacy data is adequately protected. For instance, when a commodity-type OS such as Windows or Linux experiences a critical fault, the system must generally be entirely rebooted. This involves reinitializing the memory and re-loading software constructs. As a result, in many cases, the operating environment, as well as much or all of the data that was resident in memory, at the time of the fault are lost. The system is therefore incapable of re-starting execution at the point of failure. This is unacceptable in applications that require very long times between system stops.

In addition to the foregoing limitations, commodity OSes such as UNIX and Linux allow operators a large degree of freedom and flexibility to control and manage the system. For instance, a user within an UNIX environment may enter a command from a shell prompt that could delete a large amount of data stored on mass storage devices without the system either intervening or providing a warning message. Such actions may be unintentionally initiated by novice users who are not familiar with the often cryptic command shell and other user interfaces associated with these commodity OSes.

A method and system that address these and other related issues are therefore desirable.

### SUMMARY OF THE INVENTION

The various embodiments of the invention provide methods and systems for stabilizing an emulated system. In one approach, a first operating system (OS) is executed on an instruction processor, the first OS including instructions native to the instruction processor. A second OS and a plurality of application programs are emulated on the first OS. The second OS polls the first OS for memory statistics of the first OS. The memory statistics indicate a current state of operating parameters of the memory of the data processing system used by the first OS in managing the data processing system. The second OS controls a number of the application programs allowed to execute in response to the memory statistics provided by the first OS to the second OS.

An emulation system is provided in another embodiment. The system includes a data processing system having at least one instruction processor coupled to a memory. A first operating system (OS) is executable on the instruction processor and includes instructions of a first instruction set that are native to the instruction processor. Means are provided for emulating a second OS and a plurality of application programs on the first OS. The second OS and application programs include instructions of a second instruction set that are not native to the instruction processor. The system further includes means for periodically requesting by the emulated second OS for memory statistics from the first OS. The memory statistics indicate a current state of operating parameters of the memory of the data processing system used by the first OS in managing the data processing system. Means are provided for limiting execution of the application programs by the second OS in response to the memory statistics provided by the first OS to the second OS.

Another embodiment of an emulation system comprises a data processing system including at least one instruction processor coupled to a memory, and a first operating system (OS) executing on the at least one instruction processor. The first OS includes instructions of a first instruction set that are native to the instruction processor. The emulation system further includes an instruction processor emulator executable on the at least one instruction processor. The instruction processor emulator emulates execution of instructions of a second instruction set that are not native to the at least one instruction processor. A second OS and a plurality of application programs are emulated on the instruction processor emulator. The second OS and application programs include instructions of a second instruction set that are not native to the instruction processor. The second OS executes program code that performs the steps including, periodically requesting memory statistics from the first OS. The memory statistics indicate a current state of operating parameters of the memory of the data processing system used by the first OS in managing the data processing system. The steps further include determining whether the current state of operating parameters indicated by the memory statistics is acceptable or unacceptable. A selecting step, in response to the current state being unacceptable. selects between terminating one or more of the plurality of application programs and returning to the first OS memory that is allocated to the second OS. The steps further include performing the selected one of terminating one or more application programs and freeing memory.

The above summary of the present invention is not intended to describe each disclosed embodiment of the present invention. The figures and detailed description that follow provide additional example embodiments and aspects of the present invention.

### BRIEF DESCRIPTION OF THE DRAWINGS

FIG. 1 is a block diagram of an exemplary commodity-type data processing system that may be adapted for use with the current invention.

FIG. 2 is a block diagram of one embodiment of the current invention.

FIG. 3 is a block diagram of constructs established by a legacy operating system (OS) during a boot session.

FIG. 4 is a timeline illustrating events that occur during a boot session of a legacy operating system.

FIG. 5 is a timeline that represents multiple successive boot attempts for legacy OS according to the current invention.

FIGS. 6A, 6B, and 6C are a flow diagram of one method of booting an operating system according to the current invention.

FIG. 6D is a flow diagram that illustrates one method of handling an error that occurs during the boot process of FIGS. 6A-6C.

FIGS. 7A and 7B, when arranged as shown in FIG. 7, are a flow diagram of a process performed by an operating system according to the current invention.

FIG. 7C is a flow diagram that illustrates processing performed to recover the memory associated with a Recovery Bank Area.

FIG. 8 is a block diagram of an analysis system used to analyze state save files.

FIG. 9 is a block diagram of the paging logic according to one embodiment of the invention.

FIG. 10 is a flow diagram of a state save analysis process according to the current invention.

FIGS. 11A and 11B, when arranged as shown in FIG. 11, are a flow diagram illustrating a method of managing state save data as it is retrieved from the state save files and stored in simulation memory.

FIG. 12 is a flowchart of an example process for monitoring memory usage by the legacy OS in order to stabilize operation of the emulated system.

FIG. 13 is a flowchart of an example process for periodically obtaining memory usage statistics of the host OS by the emulated OS and adjusting memory usage of the emulated operating system.

FIG. 14 is a flowchart of an example process for adjusting memory usage by the emulated operating system in response to the amount of free swap space being less than a threshold amount.

FIG. 15 is a flowchart of an example process for adjusting memory usage by the emulated operating system in response to the amount of free memory being available to the emulated operating system being less than a threshold amount.

### DETAILED DESCRIPTION OF THE INVENTION

Data Processing System Environment

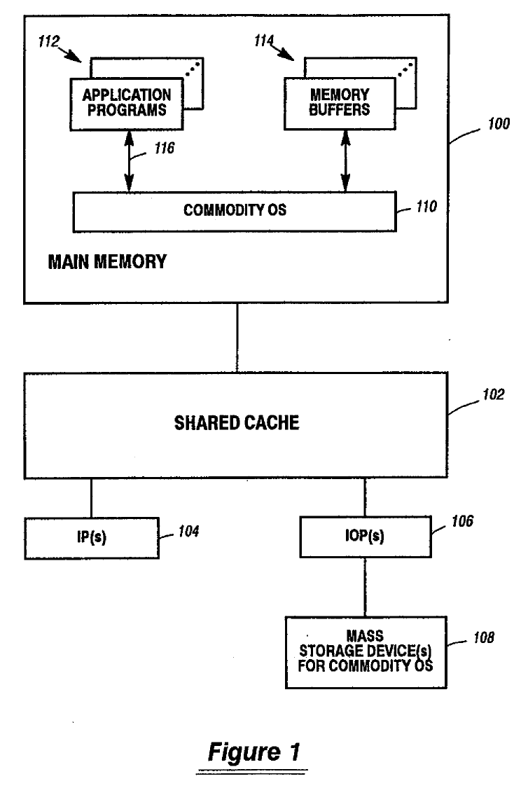

FIG. 1 is a block diagram of an exemplary commodity-type data processing system such as a personal computer, workstation, or other “off-the-shelf” hardware (hereinafter “commodity platform”) that may be adapted for use with the current invention. This system includes a main memory 100, which may optionally be coupled to a shared cache 102 or some other type of bridge circuit. The shared cache is, in turn, coupled to one or more instruction processors (IPs) 104. In one embodiment, the instruction processors include commodity-type IPs such as are available from Intel Corporation, Advanced Micro Devices Incorporated, or some other vendor that provides IPs for use in commodity platforms.

In the exemplary system of FIG. 1, Input/Output processors (IOPs) 106 are coupled to shared cache. The IOPs provide access to mass storage devices 108, which may be disk drives and other devices suitable for storing retentive data.

A commodity operating system (OS) 110 such as UNIX, Linux, WINDOWS® operating systems, or any other operating system adapted to operate on a commodity platform resides within main memory 100 of the illustrated system. The commodity OS is responsible for the management and coordination of activities and the sharing of the resources of the data processing system.

Commodity OS 110 acts as a host for Application Programs (APs) 112 that run on data processing system. For instance, if an AP requires use of one or more memory buffer 114 to perform one or more tasks, the AP makes a call to the commodity OS 110 for memory allocation. This call may be made via a standard Application Programming Interface (API) 116 that is provided for this purpose. The OS allocates a buffer of the requisite size and returns the address to this buffer in virtual address space. When the AP no longer requires use of the buffer, the AP makes a call to the OS to release that memory space so that it may be used for other purposes.

One limitation associated with use of commodity OS 110 involves data security. In some applications involving transportation, utility, government, banking, military, and other large-scale data processors, it is very important that data stored within mass storage device(s) 108 and in memory 100 be maintained in a secure state. The type of data protection and security mechanisms needed to accomplish this are not generally provided by commodity OSes. As an example, a commodity OS such as Linux utilizes an in-memory cache (not shown) to boost performance. This type of software cache that resides in main memory 100 may store data that has been retrieved from mass storage devices 108. Based on the types of requests made by APs 112, some updates to the cached data may be retained within main memory 100 and not written back to mass storage devices 108 for a long period of time. Other updates may be stored directly to the mass storage devices 108. This may lead to a “data coherency” problem wherein an older update that had been retained within memory for a long period of time eventually overwrites newer data that was stored directly to the mass storage devices. A commodity OS will generally not guard against this undesired result. Instead, the application programmer must ensure that this type of operation does not occur. This becomes increasingly difficult in a multi-processing environment wherein many different applications are making memory requests concurrently.

In addition to the foregoing limitation, commodity OSes such as UNIX and Linux operating systems allow operators a large degree of freedom and flexibility to control and manage the system. For instance, a user within a UNIX environment may enter a command from a shell prompt that could, delete a large amount of data stored on mass storage devices without the system either intervening or providing a warning message. Such actions may be unintentionally initiated by novice users who are not familiar with the often cryptic command shell and other user interfaces associated with these commodity OSes.

Other limitations associated with commodity OSes involve recoverability following a system failure. Often times, when a critical error occurs within a commodity data processing platform, a “hard reboot” must be performed. This involves completely reinitializing the hardware as though power had just been applied to the hardware. When this occurs, main memory 100, IPs 104, and IOPs 106 are reinitialized. The state in which the machine was operating at the time the fault occurred is lost. Data resident in memory at the time of the fault is also generally lost. Therefore, execution cannot be resumed at the point at which the failure occurred. This is not acceptable when running applications that require a long mean time between failures and system stops. This is also not acceptable if critical data is being manipulated by the data processing system.

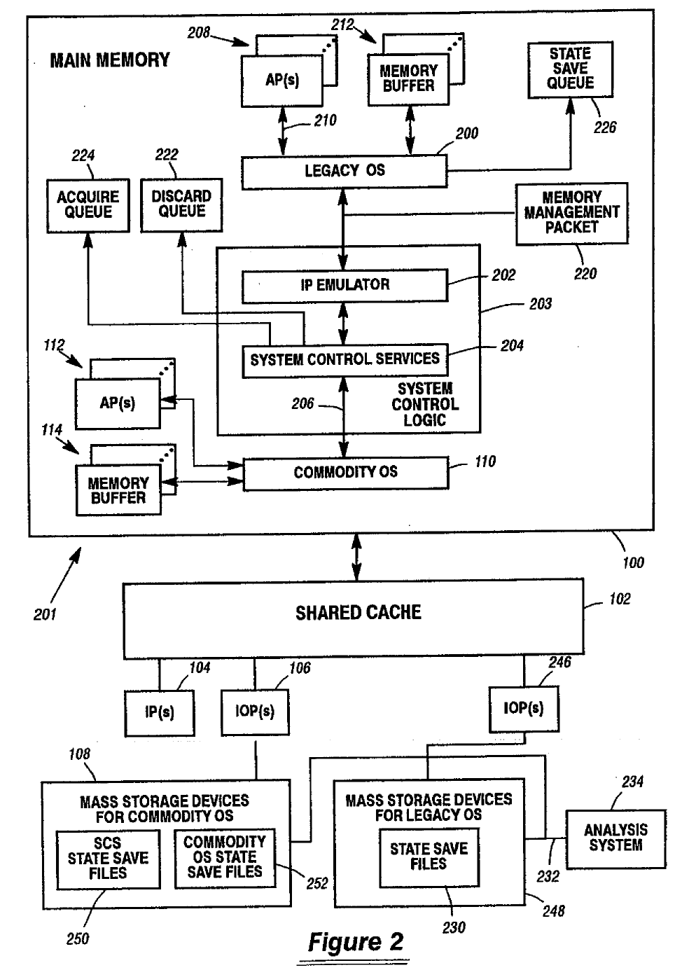

FIG. 2 is a block diagram of one exemplary embodiment of a data processing system that adapts the platform of FIG. 1 according to the current invention. In FIG. 2, elements similar to those of FIG. 1 are assigned like numeric designators. According to the illustrated system, a legacy OS 200 of the type that is generally associated with mainframe systems is loaded into main memory 100. This legacy OS may be the 2200 OS commercially available from Unisys Corporation, or some other similar OS. This type of OS is adapted to execute directly on a “legacy platform”, which is an enterprise-level platform such as a mainframe that typically provides the data protection and recovery mechanisms needed for applications that are manipulating critical data and/or must have a long mean time between failures. Such systems also ensure that memory data is maintained in a coherent state. In one exemplary embodiment, an exemplary legacy platform may be a 2200 data processing system commercially available from the Unisys Corporation. Alternatively, this legacy platform may be some other enterprise-type environment.

In one adaptation, legacy OS 200 may be implemented using a different machine instruction set (hereinafter, “legacy instruction set”, or “legacy instructions”) than that which is native to IP(s) 104. This legacy instruction set is the instruction set which is executed by the IPs of a legacy platform on which legacy OS was designed to operate. In this embodiment, the legacy instruction set is emulated by IP emulator 202.

IP emulator 202 may include any one or more of the types of emulators that are known in the art. For instance, the emulator may include an interpretive emulation system that employs an interpreter to decode each legacy computer instruction, or groups of legacy instructions. After one or more instructions are decoded in this manner, a call is made to one or more routines that are written in “native mode” instructions that are included in the instruction set of IP(s) 104. Such routines emulate each of the operations that would have been performed by the legacy system.

Another emulation approach utilizes a compiler to analyze the object code of legacy OS 200 and thereby convert this code from the legacy instructions into a set of native mode instructions that execute directly on IP(s) 104. After this conversion is completed, the legacy OS then executes directly on IP(s) without any run-time aid of emulator 202. These, and/or other types of emulation techniques may be used by IP emulator 202 to emulate legacy OS 200 in an embodiment wherein OS 200 is written using an instruction set other than that which is native to IP(s) 104.

IP emulator 202 is coupled to System Control Services (SCS) 204. Taken together, IP emulator 202 and SCS 204 comprise system control logic 203 (shown dashed) that provides the interface between legacy OS 200 and commodity OS 110. For instance, when legacy OS makes a call for memory allocation, that call is made via IP emulator 202 to SCS 204. SCS translates the request into the format required by API 206. Commodity OS 110 receives the request and allocates the memory. An address to the memory is returned to SCS 204, which then forwards the address, and in some cases, status, back to legacy OS 200 via IP emulator 202. In one embodiment, the returned address is a C pointer that points to a buffer in virtual address space.

SCS 204 also operates in conjunction with commodity OS 110 to release previously-allocated memory. This allows the memory to be re-allocated for another purpose. SCS 204 utilizes discard queue 222 and acquire queue 224 to perform some of the release operations in a manner to be described below.

Application programs (APs) 208 communicate directly with legacy OS 200. These APs may be of a type that is adapted to execute directly on a legacy platform. APs 208 may be, for example, those types of applications that require enhanced data protection, security, and recoverability features generally only available on legacy platforms. The configuration of FIG. 2 allows these types of APs 208 to be migrated to a commodity platform.

Legacy OS 200 receives requests from APs 208 for memory allocation and for other services via interface(s) 210. Legacy OS 200 responds to memory allocation requests in the manner described above, working in conjunction with IP emulator 202, SCS 204, and commodity OS 110 to fulfill the request. Legacy OS 200 tracks the buffers 212 that have been allocated to it or one of the APs 208 using data constructs to be described further below.

The system of FIG. 2 may further support APs 112 that interface directly with commodity OS 110 as discussed above in reference to FIG. 1. Commodity OS may allocate memory buffers 114 for use by these APs. In this manner, the data processing platform supports execution of APs 208 that are adapted for execution on enterprise-type legacy platforms, as well as APs 112 that are adapted for a commodity environment such as a PC.

In one embodiment, the system of FIG. 2 further includes mass storage devices 108 that store the data utilized by commodity OS 110 and the APs 112 to which this OS interfaces. Other mass storage devices 248 are provided to store data utilized by legacy OS 200 and the APs 208 to which that OS interfaces. Mass storage devices 248 are coupled to the system via IOP(s) 246. The hardware and software modules of the system of FIG. 2 provide suitable means for emulating the legacy OS 200 and application programs 208 and implementing the various method steps described herein.

Before continuing with a description of the memory polling mechanism, interfaces between legacy OS 200 and commodity OS 110 are described. As discussed above, legacy OS 200 executes an instruction set that is adapted to run directly on instruction processors of the enterprise-type system, rather than the commodity platform shown in FIGS. 1 and 2.

When operating in a legacy environment, legacy OS 200 uses a paging mechanism to manage memory directly. That is, the legacy OS has visibility into both physical and virtual address spaces. In contrast, according to the various embodiments of the current invention, the legacy OS only has visibility to the virtual address space. In one embodiment, the legacy OS uses 72-bit C pointers to address this virtual address space. Addressing within physical address space (that is, the addressing that is used to access physical memory devices) is provided by the commodity OS 110.

When executing and being emulated on a commodity platform of the type shown in FIG. 2, the commodity OS may be referred to as the host OS. The legacy OS 200 performs memory management functions with the help of system control logic 203 as follows. When the system is being newly-initialized, system control logic 203 loads and initializes IP emulator 202. During this process, system control logic 203 also acquires the memory area that will be used to start the booting process for the legacy OS 200. System control logic 203 loads the legacy OS 200 load program into this memory area and informs the IP emulator 202 to begin execution of these instructions. This begins the legacy OS boot process.

Once the boot process has begun on IP emulator 202, system control logic 203 provides the memory management interface between the legacy OS and the commodity OS. In particular, when the legacy OS requires memory allocation, a request is made to the IP emulator 202 which emulates instruction processing of a legacy instruction set. The IP emulator translates the request and forwards it to SCS, which may perform some additional processing. SCS 204 eventually makes a corresponding request to commodity OS 110. The commodity OS will satisfy the request to allocate memory, and will return to legacy OS 200 a virtual address pointing to the allocated memory. In one embodiment, the returned virtual address is a C pointer.

In one embodiment, the legacy OS submits requests for memory allocation to system control logic 203 using an Instruction Processor Control (IPC) instruction. The IPC instruction is part of the hardware instruction set of the legacy IP on which legacy OS is adapted to execute. The IPC instruction is executed on a legacy platform to initiate various control functions in the hardware, most of which are beyond the scope of the current invention. According to one embodiment of the current invention, a new memory management sub-function is defined for the IPC instruction. This sub-function is used to communicate with system control logic 203. This new memory management sub-function is encoded into a predetermined function field of the IPC instruction. When legacy OS executes an IPC instruction that includes this sub-function, IP emulator 202 expects that the contents of emulated processor registers A1 and A2 contain an address that points to a memory management packet 220 in memory. In one embodiment, the contents of these registers are concatenated to form a C pointer in virtual address space that points to this packet 220. In another embodiment, the address could be passed in another manner.

According to another embodiment of the invention, the system of FIG. 2 provides state save capabilities. For example, legacy OS 200 utilizes state save queue 226 to create state save files 230 shown stored on mass storage devices for legacy OS 248. Likewise, SCS 204 and commodity OS 110 create state save files 250 and 252, which are shown stored on mass storage devices 108. All of these files contain data that describes the state of the system at the time of a fault occurrence. This data may be transferred to another system such as analysis system 234 so that error analysis may be performed. This will be described in detail below.

As discussed above, legacy OS 200 provides enhanced data protection and system recovery capabilities generally not available from commodity OS 110. However, the configuration of FIG. 2 poses some challenges where memory management is concerned, particularly in regards to recovery scenarios. This relates to the fact that both legacy and commodity OSes are tracking allocated memory. That is, legacy OS 200 is tracking allocation of memory buffers 212, and commodity OS 110 is tracking the allocation of all memory, including memory buffers 114 and 212. This activity must remain synchronized or “memory leaks” will occur. A memory leak is an area of memory that becomes unusable because commodity OS 110 records that the area has as been allocated to legacy OS 200, but legacy OS has lost track of that area because of some type of failure.

As an example of the foregoing, assume a failure associated with legacy OS 200 causes its memory allocation records to become corrupted. Because of failure recovery techniques, legacy OS 200 is able to recover portions of its operating environment and resume execution. Because of the corruption, however, legacy OS no longer retains a record of the allocation of one or more of the memory buffers 212. Never-the-less, commodity OS 110 retains a record of this memory allocation, and therefore will not allocate the memory to any other use. In this scenario, the buffers in question will not be used by legacy OS, and will never be re-allocated to any other purpose. Therefore, this memory “leak” results in an area of unusable memory.

The current invention addresses the problems that arise when multiple disparate OSes are executing on the same platform in the above-described manner. The invention provides a mechanism to synchronize the memory management functions of these OSes to prevent memory leaks from developing.

### Communication Interface

Before continuing with a description of the synchronization mechanism, interfaces between legacy OS 200 and commodity OS 110 are described. As discussed above, legacy OS 200 executes an instruction set that is adapted to run directly on instruction processors of an enterprise-type system, rather than the commodity platform shown in FIGS. 1 and 2. In one embodiment, legacy OS 200 is a 2200 operating system commercially available from Unisys Corporation that is adapted to run on a 2200-style system, also commercially available from Unisys Corporation.

When operating in a legacy environment, legacy OS 200 uses a paging mechanism to manage memory directly. That is, legacy OS has visibility into both physical and virtual address spaces. In contrast, according to the current invention, legacy OS only has visibility to the virtual address space. In one embodiment, the legacy OS uses 72-bit C pointers to address this virtual address space. Addressing within physical address space (that is, the addressing that is used to access physical memory devices) is supported by the commodity OS 110.

When executing on a commodity platform of the type shown in FIG. 2, legacy OS 200 performs memory management functions with the help of system control logic 203 as follows. When the system is being newly-initialized, system control logic 203 loads and initializes IP emulator 202. During this process, system control logic 203 also acquires the memory area that will be used to start the booting process for the legacy OS 200. System control logic 203 loads the legacy OS 200 load program into this memory area and informs the IP emulator 202 to begin execution of these instructions. This begins the legacy OS boot process.

Once the boot has begun executing on IP emulator 202, system control logic 203 provides the memory management interface between legacy OS and commodity OS. In particular, when legacy OS 200 requires memory allocation, legacy OS 200 makes a request to the IP emulator 202 which emulates the legacy OS instruction set. The IP emulator translates the request and forwards it to SCS, which may perform some additional processing. SCS 204 eventually makes a corresponding request to commodity OS 110. Commodity OS will satisfy the request to allocate memory, and will return to legacy OS 200 a virtual address pointing to the allocated memory. In one embodiment, the returned virtual address is a C pointer.

In one embodiment, legacy OS submits requests for memory allocation to system control logic 203 using an Instruction Processor Control (IPC) instruction. The IPC instruction is part of the hardware instruction set of the legacy IP on which legacy OS is adapted to execute. The IPC instruction is executed on a legacy platform to initiate various control functions in the, hardware, most of which are beyond the scope of the current invention. According to the current invention, a new memory management sub-function is defined for the IPC instruction. This sub-function is used to communicate with system control logic 203. This new memory management sub-function is encoded into a predetermined function field of the IPC instruction. When legacy OS executes an IPC instruction that includes this sub-function, IP emulator 202 expects that the contents of emulated processor registers A1 and A2 contain an address that points to a memory management packet 220 in memory. In one embodiment, the contents of these registers are concatenated to form a C pointer in virtual address space that points to this packet 220. In another embodiment, the address could be passed in another manner.

According to the current invention, memory management packet takes the format shown in Table 1, as follows:

TABLE 1
Memory Management Packet

| Word | Contents |
|---|---|
| 0 | Version |
| 1 | Function |
| 2 | Output Status |
| 3-15 | Function Unique |

The first column of Table 1 indicates a word position within the memory management packet, and the second column indicates the contents of the corresponding word. For instance, word 0 (that is, the first word of the packet) contains a version number. This version indicates the current revision of the packet. This version may be incremented in the future as new fields are added to the packet to accommodate new functionality in legacy OS 200 and/or system control logic 203.

The next word in the packet, word 1, provides the specific memory management function that is being issued by legacy OS 200 to system control logic 203. Word 2 provides an output status that will be provided by commodity OS 110 to describe whether the function completed execution successfully. Thus, legacy OS 200 will leave this field unused when a packet is constructed to be provided by legacy OS to commodity OS 110. Finally, words 3-15 are unique to a given function, and will be described further below.

In one embodiment of the invention, each of the fields contained within memory management packet 220 are 36 bits wide to conform to a word size used by legacy OS 200. In contrast, main memory 100 of one embodiment has a word size of 64 bits. Therefore, each word of the packet uses only part of a memory word. In one embodiment, the 36 bits of a packet word are right-justified to occupy the least-significant bits of a memory word. Of course, many other embodiments are possible, including an embodiment wherein the size of the word used by legacy OS 200 and main memory 100 are the same width.

As discussed above, word 1 of the memory management packet 220 provides a function. The various functions are shown in Table 2.

TABLE 2
IPC Functions

| IPC Function | Function Purpose |
|---|---|
| Acquire | Acquire an address range |
| Release | Release an address range |
| Discard | Dispose of recovered memory. |
| Set Attribute | Add an attribute to an area of previously-acquired |
| | memory |
| Clear Attribute | Remove an attribute from an area of previously-acquired |
| | memory |
| Pin | Fix the indicated range of addresses in physical memory |
| | (“Lock”) |
| Unpin | Release the “pin” on indicated range of addresses |
| | (“Unlock”) |
| Recovery Start | Legacy OS is beginning recovery of a previous session's |
| | memory |
| Recovery | Legacy OS has completed recovery of a previous |
| Complete | session's memory |
| Initialize | Fill an area of memory with the indicated bit pattern |
| Recover | Recover an area of memory allocated to a previous boot |
| | session |
| Retrieve | Retrieve a copy of an allocated area of memory |
| Memory | Retrieve memory usage statistics from the |
| Statistics | commodity OS |

Each of the functions in Table 2 performs a respective operation associated with memory management. Many of these functions operate on an entire “memory bank”. For purposes of the remaining disclosure, a memory bank refers to an area in virtual address space that may be of any specified size, is assigned the same characteristics, and is to be used for the same purpose. For example, legacy OS may request a 32K-byte memory bank that will store data. This means that this memory bank is designated as having the characteristic of being a “data” bank that will not store instructions.

Each of the IPC functions listed in Table 2 is discussed in turn in the following paragraphs.

### Acquire Function

First, the Acquire function is considered. As shown in Table 2, this function is used by legacy OS 200 to acquire a contiguous range of memory in virtual address space for its own use, or for use by one of APs 208. To do this, legacy OS builds a memory management packet 220 in a predetermined location in main memory using the format shown in Table 3.

TABLE 3
Acquire Function

| Word | Content |
|---|---|
| 0 | Version |
| 1 | Function (Acquire) |
| 2 | Status |
| 3 | Area_Size |
| 4 | Attributes |
| 5-6 | Area_Cptr |
| 7-8 | Pattern_Cptr |
| 9 | Pattern_Length |
| 10-15 | Reserved |

Table 3 lists the format of memory management packet 220 when the Acquire function is specified in word 1 of the packet. As shown, words 0-2 are in the format described above in reference to Table 1, and words 3-15 are in a form specific to the Acquire function. Specifically, word 3 provides an indication of the size of the memory area that is to be acquired. In one embodiment, this word must contain a non-zero positive integer that specifies the number of words to be acquired. Legacy OS views these words to be of the size that conforms to that used on a legacy platform, which in one embodiment is 36 bits wide.

Word 4 of the memory management packet contains attributes that are assigned to the acquired area of memory. Use of the attributes is discussed further below.

Words 5 and 6, when concatenated, comprise an address provided by commodity OS 110 in response to the Acquire function. This address points to the memory area that was allocated in response to this request. In one embodiment, this pointer is a 72-bit C pointer that will be aligned on a 4K word (32K byte) memory boundary.

Words 7and 8, when concatenated, comprise an address provided by legacy OS 200. This address points to a memory buffer that contains a pattern that will be used to initialize the newly-allocated area of memory. In one embodiment, this address is a 72-bit C pointer. The length of this pattern is provided in word 9 of the packet, which must be non-zero and which must be evenly divisible into the size of the acquired memory area, as indicated by word 3. This pattern is only used when a corresponding “Initialize with Pattern” attribute is selected in word 4 of the packet.

As discussed above, word 4 of the packet shown in Table 3 may identify one or more attributes that are to be assigned to the allocated area of memory. These attributes are listed in Table 4.

TABLE 4
IPC Memory Attributes

| Bit Position | Attribute |
|---|---|
| 0 | Pinned in Memory |
| 1 | Initialize with Pattern |
| 2 | Include in Legacy OS State_Save |
| 3 | Candidate for a “large” underlying H/W page |

In one embodiment, word 4 is a master-bitted field. The first column indicates the bit position assigned to the attribute, and the second table column identifies the corresponding attribute. Bit 0 (the least significant bit) is set to a predetermined state if the allocated area in memory is to be “pinned” (i.e., “nailed”) in memory. When an area is pinned in memory, that area is not eligible to be paged out of main memory and stored to mass storage device(s) 248. This may be desirable, for instance, if a memory buffer is being allocated for use in performing an I/O operation.

Bit 1 of word 4 is set to the predetermined state if the allocated memory area is to be initialized with a pattern in the manner described above. As discussed above, if a memory management packet is associated with the Acquire function, and if bit 1 of the attributes field is set, words 7-8 of the packet will be set to the area in memory containing the initialization pattern, and word 9 will contain the pattern length.

Bit 2 of word 4 is set to the predetermined state if the allocated area of memory is to be included in saved state information that is collected by legacy OS 200 in the event of a failure. This saved state is information that may describe part, or all, of the state of the machine at the time the failure occurred. This information, which may include the contents of part, or all, of main memory 100, may be stored to mass storage device(s) 248 for use for debug and/or recovery purposes. More information on use of the state-save function is provided below.

Finally, bit 3 is set to the predetermined state if the memory being allocated is a candidate for a “large” underlying hardware page. When this bit is set, system control logic 203 is informed that special optimization processing is to be performed on the acquired memory. This is largely beyond the scope of the current invention.

When legacy OS 200 requests that memory be associated with one or more attributes using the above-described functionality, legacy OS and/or SCS 204 may record this attribute in their respective memory management constructs, depending on implementation. For instance, in one embodiment, SCS maintains a table or other construct that records that a particular memory area has been associated with one or more functions. These attributes are then used to perform memory management tasks. For instance, if SCS 204 is making a call to commodity OS to release an area of memory so that it may be re-allocated for a different use, and if SCS 204 determines that the area of memory is associated with the “pinned” attribute, SCS 204 will first make a call to the commodity OS to unpin that area of memory before issuing the request to release the memory. This is discussed further below.

Release Function

The Release function is the counterpart to the Acquire function discussed above. Rather than acquiring memory, this function releases an area of memory so that it may be re-allocated for a different use. The memory management packet defined for the Release function is similar to that shown in Table 3 above. Words 0-2 provide a version, function (in this case the “Release” function), and status respectively.

Word 3 of the Release function packet indicates the size of the memory area that is to be released. In one embodiment, this word must contain a non-zero positive integer that specifies the number of words to be released. Legacy OS views these words to be of the size that conforms to that used on a legacy platform, which in one embodiment is 36 bits wide.

In the case of the Release function, word 4 of the packet contains a Delayed Flag that indicates whether the “actual” release is to be deferred. This will be discussed further below.

Words 5 and 6 provide the address of the area in main memory 100 that is to be released. In one embodiment, the address is a C pointer that must start on a 4K-word boundary in virtual address space. The remaining words 7-15 are unused and reserved for future use.

Discard Function

The Discard function is used to recover and release memory after a failure occurs involving the legacy OS or its operating environment. In this type of scenario, SCS 204 will first determine that such a failure occurred. SCS will re-load and re-initiate execution of legacy OS 200. Legacy OS re-establishes its operating environment and memory map needed for that new boot session. After this occurs, legacy OS may be required to recover and release the memory that had been allocated to the previous boot session during which the failure occurred, as well as the memory allocated to one or more other previous boot sessions.

To release memory from a previous session in the above-described manner, legacy OS executes the IPC instruction with the Discard function selected. The memory management packet used for this function is similar to that employed for the Release and Acquire functions. Words 0-2 are used for version, function, and status, respectively. Word 3 indicates the size of the memory area being released. Words 4 and 7-15 are reserved, and words 5 and 6 provide the address of the area in main memory 100 that is to be released. In one embodiment, this address is a C pointer that must start on a 4K-word boundary in virtual address space.

The manner in which the Discard function is used will be discussed further below. At this time, it is sufficient to note that the Discard function operates in a deferred manner. That is, when legacy OS issues this function to SCS 204, SCS will not immediately call commodity OS 110 to release the specified memory area. Instead, SCS will create a record of this memory area on a queue or some other data structure. When legacy OS 200 indicates that a specific “Recovery Complete” time has arrived in the re-boot process, SCS is now free to make a request to the commodity OS 110 to release this memory. This will be described in detail below.

Set Attribute Function

The Set Attribute function is described in reference to Table 5.

TABLE 5
Set Attribute Function

| Word | Content |
|---|---|
| 0 | Version |
| 1 | Function (Memory Management Set Attribute) |
| 2 | Status |
| 3 | Data_Size |
| 4 | Attributes |
| 5-6 | Data_Cptr |
| 7-8 | Pattern_Cptr |
| 9 | Pattern_Length |
| 10-15 | Reserved |

The Set Attribute function is used to add an attribute to a previously-allocated area of memory. The attributes that may be added to the memory area are described above in reference to Table 4.

The memory management packet includes words 0-2, which are used in the manner described above. Word 3 indicates the size of the memory block to which the attributes will be added. In one embodiment, this field must contain a non-zero positive integer that specifies the number of words to which the attributes will be added. Legacy OS views these words to be of the size that conforms to that used on a legacy platform, which in one embodiment is 36 bits wide.

Word 4 of the packet identifies the attributes that will be added to the area of memory. This field is provided in the format described in regards to Table 4, above. Words 5 and 6 contain the address of the memory area to which the attributes will be added. In one embodiment, the address is a C pointer that must start on a 4K-word boundary in virtual address space.

When the “Initialize with Pattern” Attribute is selected in Word 4, the contents of Words 7 and 8 contain an address that points to a memory buffer. This buffer stores a pattern used to initialize the specified area of memory. In one embodiment, this address is a 72-bit C pointer. The length of this pattern is provided in Word 9 of the packet, which must be non-zero and which must be evenly divisible into the size of the memory area that is identified by Word 3. If the “Initialize with Pattern” attribute is not specified in Word 4, the pattern length in Word 9 must be zero.

Clear Attribute Function

The memory management Clear Attribute function is similar to the memory management Set Attribute function. The memory management packet used for this function is similar to that shown in Table 5. Specifically, Words 0-2 are used for version, function, and status, respectively. Word 3 indicates the size of the memory block for which the attributes will be cleared. In one embodiment, this field must contain a non-zero positive integer that specifies the number of words to be released. Legacy OS views these words to be of the size that conforms to that used on a legacy platform, as discussed above.

Word 4 of the packet identifies the attributes that will be cleared for the area of memory. This field is provided in the format described in regards to Table 4, above. Words 5 and 6 contain the address of the memory area for which the attributes will be cleared. In one embodiment, the address is a C pointer that must start on a 4k-word boundary in virtual address space. Words 7-15 are unused and reserved.

Both the Set Attribute and Clear Attribute functions may be used to set attributes on, or clear attributes from, a subset of an allocated memory area. For instance, if a 4K-word buffer in virtual address space has been previously allocated, the Set Attribute function may be used to add one or more additional attributes to a subset of the memory range allocated to this buffer. That subset may reside at the beginning, middle, or end of the buffer.

Pin Function

Next, the Pin function is described in regards to Table 6.

TABLE 6
Pin Function

| Word | Content |
|---|---|
| 0 | Version (1) |
| 1 | Function (7) |
| 2 | Status |
| 3 | Data_Size |
| 4 | Reserved |
| 5-6 | Data_Cptr |
| 7-15 | Reserved |

The Pin function is used to fix an address range in physical memory, as discussed above. This ensures that the area of memory remains resident and is not relocated. In other words, the allocated memory will not be paged out of main memory to mass storage device(s) 108 and/or 248. Additionally, the physical memory allocated to the virtual address space will not be changed. The Pin function may be specified for a subset of an allocated memory range.

The packet for the Pin function utilizes words 0-2 in the manner described above. Word 3 contains the size of the memory area that is to be pinned. In one embodiment, this field must contain a non-zero positive integer that specifies the number of words to be released. Legacy OS views these words to be of the size that conforms to that used on a legacy platform, as discussed above. Words 5 and 6 contain the address of the memory area that will be pinned. In one embodiment, the address is a C pointer that must start on a 4K-word boundary in virtual address space. Words 4 and 7-15 are unused and reserved.

Unpin Function

An Unpin function that is similar to the Pin function is also provided. This function releases any prior “pin” request so that the memory to be paged to mass storage device(s), or so that the physical memory allocated to the virtual memory space may be changed. The address range specified for the Unpin function may be a subset of a larger allocated memory area.

The format of the packet for the Unpin function is similar to that described above in regards to Table 6. Words 0-2 are utilized in the manner described above. Word 3 contains the size of the memory area that is to be unpinned. In one embodiment, this field specifies the number of words to be released. Legacy OS views these words as being of a size conforming to that used on a legacy platform. Words 5 and 6 contain the address of the memory area that will be unpinned. In one embodiment, the address is a C pointer that must start on a 4K-word boundary in virtual address space. Words 4 and 7-15 are unused and reserved.

Recovery Start Function

Table 7 illustrates a packet format used for a Recovery Start Function.

TABLE 7
Recovery Start Function

| Word | Content |
|---|---|
| 0 | Version |
| 1 | Function (Recovery Start) |
| 2 | Status |
| 3-15 | Reserved |

Legacy OS 200 uses the Recovery Start function to indicate to system control logic 203 that the legacy OS is beginning the task of recovering memory allocated to a previous boot session. This is done to synchronize memory allocation between legacy OS 200 and commodity OS 110 so that memory leaks do not develop. The use of this function and the procedure used to complete this synchronization are discussed in detail below.

In the packet created for this function, Words 0-2 communicate a version, function (“Recovery Start”), and status, respectively. The remaining Words 3-15 are unused, and are reserved.

Recovery Complete Function

The current system also provides a Recovery Complete function that legacy OS 200 uses to indicate to system control logic 203 that the legacy OS has completed the task of recovering memory associated with all previous sessions. After system control logic 203 receives this function, system control logic may now release any memory that was the target of either the Discard function, or alternatively was the target of the Release function that was performed with the delay flag activated. Both of those functions are deferred requests which are not completed until this Recovery Complete function is issued. This deferred operation is needed to ensure that memory leaks do not develop, as will be discussed in detail below.

The packet used for the Recovery Complete function is similar to that used for the Recovery Start function. Words 0-2 provide a version, function (“Recovery Complete”), and status, respectively. The remaining words 3-15 are unused, and are reserved.

Initialize Function

Table 8 displays the Initialize function packet format.

TABLE 8
Initialize Function

| Word | Content |
|---|---|
| 0 | Version (1) |
| 1 | Function (13) |
| 2 | Status |
| 3 | Data_Size |
| 4 | Attributes |
| 5-6 | Data_Cptr |
| 7-8 | Pattern_Cptr |
| 9 | Pattern_Length |
| 10-15 | Reserved |

The Initialize function is used to initialize an area of memory to the specified bit pattern. The packet for this function includes words 0-2 that are used in the manner described above. Word 3 indicates the size of the memory block to be initialized. This field may, in one embodiment, indicate the number of words to be initialized.

Word 4 of the packet uses the format described in regards to Table 4 to specify the Initialize attribute. Words 5 and 6 contain the address of the memory area that is to be initialized. In one embodiment, the address is a C pointer that must start on a 4K-word boundary in virtual address space.

Words 7 and 8 contain an address that points to a memory buffer. This buffer stores a pattern used to initialize the specified area of memory. In one embodiment, this address is a 72-bit C pointer. The length of this pattern is provided in word 9 of the packet, which must be non-zero and which must be evenly divisible into the size of the memory area that is identified by word 3. In one embodiment, the address stored in words 7 and 8 do not have to start on a 4K word boundary, but the entire block of data must have been allocated within a memory area.

If “Initialize with Pattern” attribute is not selected in word 4 when the Initialize function is specified, the identified area of memory is initialized to zeros. It is assumed that the pattern C pointer contained in words 7 and 8 is bound to the pattern for the entire system session.

The Initialize function may be used to initialize a subset of a larger allocated area of memory.

Recover Function

A Recover function is described in reference to Table 9.

TABLE 9
Recover Function

| | |
|---|---|
| 0 | Version (1) |
| 1 | Function (Recover) |
| 2 | Status |
| 3 | Previous_Size |
| 4 | Reserved |
| 5-6 | Previous_Area_Cptr |
| 7-8 | Current_Area_Cptr |
| 9-15 | Reserved |

The Recover function is used to recover a bank of memory that was allocated to a previous boot session. This function is used, for instance, to ensure that the previously-allocated bank is loaded into memory so that the state of a previous boot session can be saved for analysis purposes. This will be discussed below. Words 0-2 of the packet are employed in the manner discussed above. Word 3 provides the size of memory area that is being recovered. This size must be set to indicate that the entire memory bank is being recovered, and not a portion thereof. Words 4 and 9-15 are reserved. Words 5-6 store the address to the memory bank that is being recovered. In one embodiment, this address is a C pointer. Words 7 and 8 are an address that points to the memory buffer to which the data was recovered. In one embodiment, this is a C pointer.

When the Recover function is used, the memory area that is being recovered may still reside in virtual address space. That is, it may still be resident in main memory 100, or it may have been paged out to mass storage devices 108 and/or 248. In either of these cases, the Recover function will merely return the original virtual address from Words 5 and 6 in Words 7 and 8. That is, the memory area is still allocated and located at the previously-assigned address. In some cases, however, the memory area on which recovery is being attempted is no longer allocated. This happens, for instance, if a catastrophic system failure causes commodity OS 110 to perform a state save operation. While this is largely beyond the scope of the current invention, it is sufficient to note that in such cases, the data from the memory area in question must be retrieved from special state save files 252 that may be stored on mass storage device(s) 108. The data from these state save files 252 is retrieved and loaded into a newly-allocated area of main memory 100 for recovery. In this special situation, the original address provided by legacy OS in words 5 and 6 will be different from the address in words 7 and 8 that is returned by SCS 204 in the packet, since words 7 and 8 will now point to the newly-allocated memory area.

Retrieve Function

The retrieve function is similar to the Recover function described above. This function retrieves a copy of the information that is stored in the memory area pointed to by words 5 and 6 of the memory management packet. This copy is transferred to a buffer in main memory that is currently allocated to the legacy OS for use by the Retrieve function.

The primary difference between the Retrieve and Recover functions involves how the original memory area is managed. When the Recover function is used, the original data is being provided in main memory rather than a copy of the data. Thus, often times after the Recover function is issued, legacy OS may access the recovered memory bank at the memory address originally allocated for that bank. In contrast, the Retrieve function retrieves a copy of a portion, or all, of the original memory bank that has been copied to a newly-allocated area in memory. The original memory bank remains allocated in memory.

The packet format for the Retrieve function is similar to that for the Recover function. Words 0-2 of the packet are employed in the manner discussed above. Word 3 provides the size of memory area that is being retrieved. In contrast to the Recover function, the Retrieve function may select a portion of the entire allocated memory bank to retrieve. Words 4 and 9-15 are reserved. Words 5-6 store the address to the memory area that is being retrieved. In one embodiment, this address is a C pointer. Words 7 and 8 are an address of the memory area to which the contents of the original memory area was retrieved. In one embodiment, this addressed is a C pointer.

The foregoing discussion describes the IPC instruction that is used by legacy OS 200 to initiate memory management operations. In one embodiment, this instruction is part of the instruction set of an IP that would be included in a legacy platform on which legacy OS 200 is designed to operate.

When an IPC function is executed on the IP emulator 202, the memory management packet 220 is retrieved from the address of the area in memory designated by the emulated processor registers A1 and A2. The contents of the memory management packet are passed as a parameter to SCS 204. SCS utilizes this parameter to make corresponding calls via API 206 to the commodity OS 110 to initiate the requested memory management functions. In one embodiment, API 206 is the same API utilized by APs 112 when requesting memory management functions.

As discussed above, the various IPC functions are used to acquire, release, pin, initialize, assign attributes to, and remove attributes from, memory. These functions also allow legacy OS 200 to complete recovery operations during a soft reboot in a manner that ensures that memory leaks are not created. This is discussed further below.

Memory Statistics Function

The Memory Statistics function is described with reference to Table 10.

TABLE 10
Memory Statistics Function

| Word | Content |
|---|---|
| 0 | Version |
| 1 | Function (Memory Statistics) |
| 2 | Status |
| 3-5 | Reserved |
| 6 | Physical Processors |
| 7 | Paging_IO |
| 8 | Scaling Units |
| 9 | Max_Physical Memory |
| 10 | Free_Physical Memory |
| 11 | Reserved |
| 12 | Max_Virtual_Memory |
| 13 | Free_Virtual_Memory |
| 14 | Max_Swap_Space |
| 15 | Free_Swap_Space |

The Memory Statistics function is used to obtain memory utilization from the underlying commodity OS so that the legacy OS can manage memory capacity. The packet for this function includes words 0-2 that are used in the manner described above. Words 3-5 are reserved.

Words 6-15 are output as follows. Word 6 is the number of physical core processors 104. Word 7 is the number of paging I/O (in “units” granules) transferred from the swap file since the last reboot. Word 8 is the size, in bytes, of the granules in which the memory utilization statistics are expressed (i.e. 1024 bytes). Word 9 is the amount of physical memory configured (in “units” granules). Word 10 is the amount of free physical memory (in “units” granules). Free memory is memory that can be allocated immediately. Word 11 is reserved. Word 12 is the amount of virtual space configured for a single process (in “units” granules). Word 13 is the amount of free virtual space configured for a single process (in “units” granules). Word 14 is the amount of swap-file space configured (in “units” granules). Word 15 is the amount of free swap-file space (in “units” granules).

Recovery Processing

The recovery process initiated by legacy OS 200 during a soft reboot operation can be best understood by understanding the boot process generally. Assume that power is being applied to the data processing system of FIG. 2 such that a “hard” boot is being performed. In a manner known in the art, upon power-up, one or more of IPs 104 will access Read-Only Memory (ROM) or some other persistent storage device to begin execution of the Basic Input/Output System (BIOS). This code performs some testing and initialization to get the hardware running. The BIOS loads commodity OS 110 from mass storage device(s) 108 and turns over control of the system to the commodity OS. Commodity OS may then begin receiving various requests to load and execute APs 112. Commodity OS may also begin allocating memory buffers 114 for its own use, or as a result of requests received from APs 112.

One of the software entities that will be loaded into main memory 110 by commodity OS 110 is system control logic 203, which includes IP emulator 202 and SCS 204. After loading of this code is complete, a boot process included within SCS 204 makes requests via API 206 to commodity OS 110 to obtain the memory areas within main memory 100 where the legacy OS 200 load program will reside. SCS will then make the request to load the legacy OS load program from mass storage device(s) 108. This load program loads the legacy OS 200 and makes a request to commodity OS 110 to allow the legacy OS to begin executing on one or more of IPs 104.

Once legacy OS 200 begins executing, it must establish its own environment before it can perform other tasks. This involves acquiring large areas of memory that legacy OS 200 will use for memory management functions and for controlling and managing the execution of APs 208. The legacy OS is not considered booted until the entire environment has been established and is operational.

Legacy OS 200 acquires memory for use in establishing the environment by issuing IPC commands to SCS 203 using the Acquire function that is discussed above. SCS decodes and/or interprets the commands, and issues corresponding memory requests to commodity OS 110. For each such request, commodity OS 110 returns status, and if the request was successful, an address to the allocated memory area. This information is contained in a memory management packet 220 in the manner discussed above.

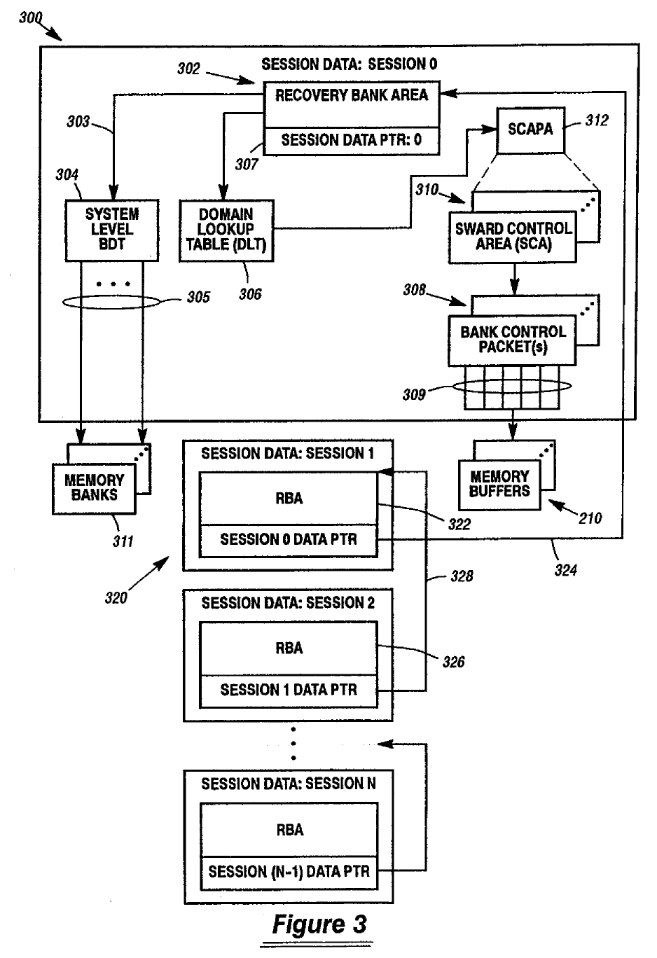

FIG. 3 is a block diagram of some of the constructs the legacy OS establishes as its operating environment during a boot session. The operating environment, which includes an extensive memory map, is referred to as “session data”. Session data is re-established each time the legacy OS 200 is re-booted. For the current example, it is assumed the system is being booted from the power-down state and is considered “session 0”. The corresponding session data 0 is shown in block 300 of FIG. 3.

In one embodiment, session data 300 includes a main Recovery Bank Area (RBA) 302. The RBA contains general operating information maintained by legacy OS 200. The RBA also contains pointers to other data constructs used by legacy OS to manage its memory areas. For instance, a system level bank descriptor table (BDT) 304 is a table that contains descriptions for all memory banks that are allocated to contain system information. System information includes any data or addresses that are being used by legacy OS 200 to establish its operating environment, including its memory map. As memory banks 311 are allocated for use by legacy OS 200, the pointers 305 to these memory banks are stored within system level BDT 304.

The system-level BDT 304 has a pointer 307 to a Domain Lookup Table (DLT) 306. The DLT is a table that contains an entry for each domain in the system. Each domain is a partition that may be allocated, and own, memory resources. Each domain may be associated with one or more processes that are executing within that domain, and that may use the memory resources allocated to the domain. Memory resources are allocated to the domain in blocks called “swards”. As a process executing in the domain needs more memory, that process is provided with memory obtained from the previously-allocated sward associated with the domain. When this memory source is depleted, another sward is allocated for the domain. Each DLT entry identifies a first sward that was assigned to the associated domain. The remaining swards for the domain are tracked by a linked list that is chained to this first sward.

The Session Data further includes a Sward Control Area Pointer Area 312 (SCAPA). This is a system level memory bank that has entries, or descriptors, that each describes and points to a respective Sward Control Area (SCA) 310. Each SCA is a memory bank that contains descriptions of still more memory banks, shown as the bank control packet banks (BCPs) 308.

Each of the BCPs contains information on a respective one of memory banks 210 that has been acquired for use by one of APs 208. Such information may include a lower address limit, the maximum memory area size, the current size, and so on. The BCPs of one embodiment are included in a linked list that is pointed to by the SCA 310. Others ones of the structures within the session data may be arranged as linked lists.

As may be appreciated from the foregoing discussion, the session data may be thought of as a complex tree structure. The RBA 302 represents the root of this tree, and the various other structures are interconnected to the root and to one another.

As described above, each time legacy OS 200 is loaded and begins execution, the legacy OS creates session data for that boot session. For instance, if a fault occurs during boot session 0 such that legacy OS 200 must undergo a soft re-boot (that is, a re-boot that does not require the removal of power from the system), legacy OS will establish new session data. This session data 320 for session 1 is formatted in the manner shown for session data 0.

Each time legacy OS 200 is re-booted in the foregoing manner, SCS 204 maintains the address of the RBA for the most recent session. For instance, assume an error occurred while legacy OS was booting during session 0. SCS retains the address for RBA 302, and then initiates a re-boot of legacy OS. This causes legacy OS to be re-loaded and to begin execution. Legacy OS 200 then re-establishes the session data 320 for session 1. Legacy OS next makes a call to SCS 204. In response, SCS stores the address of the RBA for session 0 within a session pointer field 307 of the RBA for session 1. This pointer, which is represented by arrow 324, will persist across additional boot sessions so that session 1 data remains linked to session 0 data even if another reboot occurs.

Next, assume yet another reboot occurs so that the current session is session 2. If the boot procedure for session 2 progresses far enough, SCS 204 will store the address of the session 1 RBA within the session data pointer field 307 of session 2 in the manner previously described. This is represented by arrow 328. Thus, all of the session data memory areas for previous boot sessions are organized into a linked list that is linked backwards in time. The RBA 302 for session 0 stores a null pointer to indicate that this RBA is at the end of the linked list.

As may be appreciated, the session data for a given session represents a very large amount of memory. Some of the constructs such as system level BDT 304 and bank control packet(s) 308 may point to many memory buffers that are being managed by the legacy OS during that session. Some constructs such as the system-level BDT 304 include pointers to areas in memory storing large amounts of code. The constructs themselves may also consume large areas of memory.

If a failure occurs such that legacy OS 200 must be re-booted, legacy OS 200 cannot directly re-use the memory allocated to a previous session, but instead will acquire new memory for use during that current session. Therefore, it is important that legacy OS release all memory that was used for the previous session so that it becomes available to be re-allocated by the system. Because commodity OS 110 has no visibility into a re-boot situation involving legacy OS 200, legacy OS and system control logic 203 must ensure that all memory from the previous boot sessions is released. If the release is not completed successfully, the memory allocated to those previous sessions remains designated as allocated by commodity OS 110, but is unusable by legacy OS 200 and its associated APs 208 such that one or more memory leaks will develop.

To prevent the development of memory leaks, a recovery process must be initiated each time the legacy OS 200 is re-booted. This recovery process occurs generally as follows. Assume that several failures occurred in succession during boot sessions 0 and 1. This resulted in the creation of multiple session data memory areas. These two session data areas are linked together in a linked list in the manner shown in FIG. 3. It will be assumed for this example that none of the memory allocated to any of these previous boot sessions has been released.

Assume further that legacy OS has been re-loaded and has begun executing during a next boot session, which is session 2. During this boot session, legacy OS 200 completes creation of its session data 326 for this session.

After the session data is constructed, legacy OS begins recovery processing. Initiation of this process is signaled by the legacy OS executing the IPC instruction with the Recovery Start function selected. This indicates that legacy OS is ready to begin recovering and/or discarding the memory allocated to the previous boot sessions 0 and 1. The Recovery Start function informs system control logic 203 that recovery is being initiated, and causes the system control logic to store the pointer to the RBA for the previous boot session in the session data pointer field 307 for the current boot session.

Upon completion of execution of the Recovery Start function, legacy OS 200 retrieves the newly-stored address of the RBA for the most recent boot session prior to the current boot session. This address is retrieved from the session data pointer field 307 of the current session data. For example, if the current session is session 2, legacy OS retrieves the address of the RBA for session 1 from the session data pointer field 307, which is represented by arrow 328.

Once the address for the RBA of the previous boot session is obtained, legacy OS attempts to recover a copy of the session data for the previous boot session 1. To do this, legacy OS executes the IPC instruction with the Retrieve function selected. Words 5 and 6 of the memory management packet for this function contain the address, in virtual memory space, of the memory area being retrieved. In this instance, this address is the address of the RBA. The size of the memory area being retrieved, which will be the predetermined size of the memory area containing the RBA, is stored within Word 3 of this packet.

The issuance of the Retrieve function by legacy OS causes SCS 204 to make a call to commodity OS 110 to allocate a memory buffer of adequate size. SCS 204 also makes a call to commodity OS to page the original page(s) storing the RBA into main memory, if necessary. SCS 204 then copies the data from the original page(s) into the newly-allocated buffer and returns the address of the newly-allocated buffer containing the RBA copy back to legacy OS. In one embodiment, this address is stored in words 7 and 8 of the memory management packet, as described above.

When legacy OS receives the response to the Retrieve function, legacy OS obtains the address of the copy of the RBA from words 7 and 8 of the packet. Legacy OS uses this copy to extract pointers to other constructs included in the session data. For instance, legacy OS retrieves the pointer to the system level BDT 304. In a manner similar to that described above, legacy OS issues the Retrieve function to retrieve a copy of the system level BDT for session 1.

Using the Retrieve function in the foregoing manner, legacy OS 200 retrieves a copy of each of the constructs included in the session data for session 1. Once the session data has been reconstructed, legacy OS traverses through each of the constructs to process each of the memory areas pointed to by the construct. For instance, legacy OS 200 may traverse through a linked list maintained by system level BDT 304 to obtain pointers to each of the memory banks 311 pointed to by this construct. As each entry in the linked list is encountered, legacy OS performs processing related to this memory bank. The processing either simply releases that bank (e.g., using the Discard function) so it may be re-allocated for other purposes, or saves and then releases the state of that memory bank in a manner to be described below. If may be desirable to save the state, for instance, if the data is to be analyzed for debug purposes.

Before continuing, it may be noted when legacy OS 200 is processing the memory banks pointed to by the session data, such as memory banks 311, legacy OS is processing the original memory bank, rather than a copy of that bank. This will be discussed further below.

When all memory banks that are pointed to by the session data (e.g., memory banks 311 and all memory banks containing buffers 210) have been the target of a state save operation and/or have been discarded, the memory containing the session data itself may be processed in the same way. That is, each of the memory banks that were allocated to contain session data 1, 320, may be saved and then discarded, or simply discarded. These banks may be located because their addresses are contained within the system level BDT 304 for that session.

Recall that when the legacy OS 200 is processing the session data for any given session, it is working from a copy of that session data. That is, it is using a copy to release the originally-allocated memory banks. When all memory banks used to store the original session data for session 1 have been discarded, the copy of the session data may next be released. Before this is done, legacy OS 200 retrieves the session data pointer for the next most recent session data. In the current example, this is the pointer to session 0 data, which is represented by arrow 324. Then legacy OS 200 may release the memory (e.g., using the Release function) that was allocated to store the copy of session data 1.

Next, legacy OS uses the retrieved pointer to the next most recent session data (i.e., session data 0) to repeat the process. In this manner manner, legacy OS 200 systematically traverses the linked list of session data areas, retrieving a copy of the session data area, releasing all of the memory pointed to by this session data, releasing the original memory storing that was allocated to store the session data, and finally releasing the memory allocated to store the copy of the session data. When the legacy OS 200 finally encounters the session data area storing a null value in the session data pointer field, all memory has been processed.

When the legacy OS encounters the null value in a session data pointer field, the legacy OS may have to impose a delay before the recovery process continues. This is necessary so that any required state save activities needed to retain part, or all, of the execution state will be completed.

Eventually the legacy OS 200 receives an indication that all state save operations have been completed. This triggers execution of the IPC instruction with the Recovery Complete function selected. The Recovery Complete function provides an indication to system control logic 203 that the recovery operation is completed from the legacy OS' viewpoint. Legacy OS may then store a null value in the session data pointer for the current boot session. This provides a record that all memory for all previous boot sessions prior to the current boot session has been recovered. If a re-boot must be performed in the future, legacy OS must only process the previous session 2 data, since processing for session 1 and session 0 data has been completed.

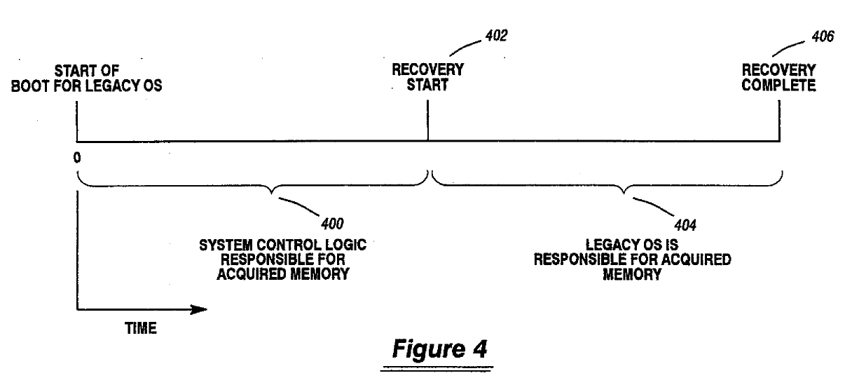

With the foregoing available for discussion purposes, a more detailed description of the way in which memory is handled during the recovery process is provided in reference to FIG. 4.

FIG. 4 is a timeline illustrating events that occur during a boot session for legacy OS. At time 0, SCS 204 loads, and initiates execution of, legacy OS 200. During the time period 400 prior to Recovery Start time 402, legacy OS 200 is performing the processing needed to build the session data for the current boot session. Until this data is completed, the legacy OS 200 cannot proceed to the recovery phase of the boot process.

As shown in FIG. 3, the session data includes complex, inter-related data structures. Legacy OS 200 does not necessarily build these structures from the “top down”. As an example, at a given instant in time, legacy OS 200 may be in the process of constructing one or more bank control packets 308, the pointers to which are not yet stored within an associated SCA 310. If a failure occurs at that moment in time, the interconnections between the various constructs of the current session data are not in place to be used to recover memory in the manner described above. In other words, if a reboot occurs, legacy OS will not be able to use the session data area to locate all memory that was allocated to the boot session, and some allocated memory could therefore become a “leak”. To prevent this from occurring, some other mechanism is needed to track the memory being allocated to the boot session during time period 400.

To address the above-described situation, SCS 204 is made responsible for recovering all memory that was acquired for the current boot session during time period 400. That is, each time legacy OS 200 uses the Acquire function to obtain memory, SCS 204 records the address and size for the allocated memory area. This information is added to an entry of an acquire queue 224 (FIG. 2). In this manner, acquire queue 224 tracks all memory that was allocated on behalf of the legacy OS 200 for the current boot session.

If no error sooner occurs, the boot of legacy OS 200 will complete enough of the construction of the data structures contained in the session data so that all pointers are in place. At this time, the legacy OS is able to locate all of the memory that was allocated to it during the current boot session merely by gaining access to the RBA. Therefore, the legacy OS may now be responsible for recovering and releasing all memory allocated on its behalf during the current boot session. At this time, the legacy OS executes the IPC instruction with the Recovery Start function selected.

When SCS 204 detects that legacy OS executed the IPC instruction with the Recovery Start function selected at time 402, SCS may discard the acquire queue 224. This may be accomplished by making a request to commodity OS to release the memory allocated to this queue. Because legacy OS 200 has reached a stage in the boot process that allows it to locate all of the memory allocated to it for the current session data, if a failure occurs during time period 404, legacy OS 200 will recover this allocated memory itself. This will be accomplished during a subsequent re-boot process in the manner described above.

In some cases, SCS 204 will not detect the execution of the IPC instruction. Instead, SCS 204 will detect that legacy OS somehow failed during the boot process such that the Recovery Start time 402 was never reached. In this case, legacy OS may not be capable of recovering all memory that was allocated to it during the current boot session. Therefore, to prevent the development of memory leaks, SCS 204 processes all entries on the acquire queue 224. For each such entry, SCS makes a request to commodity OS 110 to release the area of memory that was acquired on behalf of the legacy OS during the current boot session. When all such memory is released successfully, SCS 204 may initiate another re-boot attempt for the legacy OS.

The recovery procedure described above thereby provides a two-step boot process. During time period 400, SCS 204 tracks all acquired memory so that SCS may release the memory should a failure occur prior to Recovery Start time 402. In contrast, all memory acquired after time period 402 on behalf of the legacy OS will be released by the legacy OS during a subsequent boot session.

Next, the manner in which memory is processed during time period 404 is considered. During time period 404, legacy OS processes any unreleased memory areas that were allocated for its use during any previous boot session. To enable this, when legacy OS 200 executes the IPC instruction with the Recovery Start function selected, SCS 204 may store an address of the RBA for the most recent boot session prior to the current boot session in the session data pointer field of the current session data. SCS will only store a pointer in this manner if that previous boot session has not yet undergone recovery processing. If no previous boot session exists, or if recovery processing has already been completed for that previous boot session, SCS 204 stores a null value in the session data pointer field at this time.

Next, legacy OS 200 retrieves any pointer provided by the SCS 204. This pointer is an address to the previous session's RBA, as discussed above. Legacy OS then begins the process of reconstructing a copy of the various constructs included in the session data of the previous boot session. This is accomplished in the foregoing manner. When this reconstruction is complete, legacy OS begins traversing these constructs, including those shown in FIG. 3, to process each memory bank to which one of these constructs points. This processing may involve saving the state of the memory bank, and then releasing that bank for re-allocation. Alternatively, the memory bank may be released without performing a state save operation. Whether a memory bank is simply released, or the contents of that bank are to be saved first prior to the bank's release, is determined by control bits in the control structure that describes the memory bank. The saving of the contents, and/or release, of a memory bank occurs generally as follows.

The simplest case is considered first. This involves the scenario wherein all memory buffers associated with all session data areas are to be discarded without performing any state save operations. Legacy OS will determine a memory buffer is to be released without performing a state save operation via the state of control bits that are associated with each memory buffer, as discussed above. When the legacy OS 200 determines that a memory bank is to be released, legacy OS executes the IPC instruction with the Discard function selected. The memory management packet for this function includes the address to be discarded in Words 5-6. The size of the memory to be discarded is provided in Word 3.

When SCS 204 detects that the legacy OS has issued the Discard function in the above-described manner, SCS defers this request. This means that SCS does not immediately issue a request to commodity OS 110 to release that memory. Instead, SCS 204 builds an entry on the discard queue 222 (FIG. 2). This entry contains the size and address of the memory area to be released, as obtained from the memory management packet of the IPC instruction. This entry provides a record that the described memory area is to be released at a future time.

In the foregoing manner, each time legacy OS 200 issues the Discard function to release a memory area without performing a state save operation, SCS places another entry on discard queue 222. This queue may contain many entries representing a very large portion of main memory 100, particularly if multiple session data areas are being processed by legacy OS 202 during time period 404.

Recall that the processing performed to release memory allocated to store the session data is performed using a reconstructed copy of this session data. That copy is created using the Retrieve function, as described above. This copy is needed so that all of the original memory storing the original session data may be released while still retaining copies of the pointers needed to continue recovery processing.

After each session data area is processed, the memory allocated to store the reconstructed copy of the session data area must also be released. To do this, legacy OS 200 executes the IPC instruction with the Release function selected, and with the Delayed flag deactivated. The causes the memory allocated to store the copy to be immediately released.

After all session data areas are processed without failure in the foregoing manner, legacy OS executes the IPC instruction with the Recovery Complete function selected, as mentioned above. This marks the Recovery Complete time 406. After this point in the boot process, legacy OS may not use the discard function to release any additional areas of memory.

In response to receipt of the Recovery Complete function, SCS 204 may now begin issuing requests to release the memory areas represented by the entries on the discard queue 222. Specifically, for each such entry, SCS makes a call to commodity OS 110 via API 206 to release the described memory area. If commodity OS 110 completes a request successfully, the released memory is available for re-allocation to another process. This ensures that the memory area does not become a memory leak. When SCS processes all entries on the discard queue 222, recovery processing is complete. SCS may then release the memory allocated to the discard queue via another request to commodity OS.

The deferred release process described above is used to release the memory for one or more boot sessions for the following reason. The various constructs represented by the session data are very large and complex. Requiring legacy OS to track how far the recovery process had proceeded would be too complex, time-consuming, and would require too much memory. Therefore, this requirement is not imposed. Legacy OS therefore has no record of which memory banks were, from its viewpoint, released at any given time in the recovery process. As a result, if a failure occurs during the recovery process such that another re-boot operation must be initiated, legacy OS 200 is required to begin the recovery process from the very beginning (i.e., by processing the most recent previous boot session data.)

As an example of the foregoing, assume that legacy OS is processing a chain of three session data areas. Legacy OS is half-way through processing of the second session data area when a fatal area occurs such that legacy OS must be re-booted by SCS 204. When legacy OS once again is at a point where it may attempt the memory recovery process, legacy OS has no visibility as to how far it progressed during the previous failed recovery attempt. Therefore, legacy OS must start from the “beginning”. That is, it must obtain the address of the session data area for the most-recent previous session. According to the current example, this session data area will now be part of a chain that includes four (rather than three) such areas. Specifically, the chain includes the three areas for which recovery was being attempted when the most recent failure occurred, as well as the session data for the boot session that was active at that time. Legacy OS will again start with the session data for the most recent previous session and work backwards in time until it reaches a session data area with a null value in the session data pointer.

Another reason memory is not released immediately during a recovery attempt is because of the way the memory constructs within the session data areas are interconnected. Various pointers link the constructs, as well as entries within the constructs. Releasing any of the memory prematurely would destroy the linked lists, making it difficult or impossible to continue or re-initiate a recovery attempt if a failure occurred mid-way through the recovery process.

As mentioned above, the foregoing discussion focuses on the least complex recovery scenario wherein all memory banks from previous boot sessions are simply discarded, making them available for re-allocation. In some cases, the contents of those memory banks must be saved during a state save operation before those banks are discarded. This process is initiated by the legacy OS executing the IPC instruction with the Recover function selected. The address to be recovered is contained in Words 5-6 of the memory management packet, and the size of the memory bank to be recovered is contained in Word 3 of this packet. In one embodiment, the Recover function will only recover an entire allocated memory bank.

As discussed above, the memory bank that is being recovered may still reside at its previous location in virtual address space, which is the address contained in Words 5-6 of the packet. In this situation, SCS 204 makes a request to commodity OS 110 to ensure that the memory bank is paged into main memory, and the same address contained in Words 5-6 of the packet is returned to legacy OS in Words 7-8 of the packet.

In some cases, the memory bank that is being recovered may no longer reside within virtual address space. This occurs in a scenario wherein a critical fault occurred that caused commodity OS 110 to halt execution. Before this halt occurs, commodity OS stores the entire state of the system to the commodity OS state save files 252 on mass storage device for commodity OS 108. The commodity OS then halts. In this case, it is generally necessary to perform a cold boot, which involves re-initializing the hardware, and re-loading and re-initiating execution of the commodity OS. Booting of legacy OS 200 then proceeds according to the process described above.

After a cold re-boot occurs in the aforementioned manner, when the legacy OS 200 issues the Recover function in attempt to recover memory that was the target of the commodity OS' state save operation, the memory contents must be retrieved from state save files 252. To do this, SCS 204 acquires a new memory bank from commodity OS and copies the contents of the old memory bank from state save files 252 into this newly-acquired memory area. SCS 204 then provides the address of this new-acquired memory area to legacy OS in Words 7-8 of the packet.

After legacy OS receives the response to the Recover function, legacy OS may access the recovered data using the pointer contained in Words 7-8 of the packet. In one implementation, legacy OS uses the Acquire function to allocate another state save buffer in memory. Legacy OS copies the contents of the recovered memory bank into the newly-allocated buffer and places an entry on state save queue 226 in main memory for this buffer. A state save process of legacy OS will eventually process this queue entry by copying the contents of the newly-allocated buffer to state save files 230 that are contained on mass storage device(s) 248. These state save files are used to perform “debug” operations related to previous failures and/or to perform analysis involving prior boot sessions. This will be discussed in detail below.

Finally, legacy OS 200 uses the Release function with the Delayed flag set to release the recovered memory bank. This causes SCS 204 to add an entry to Discard queue 222 so that the recovered memory bank will be discarded if Recovery Complete time 406 is reached.

Legacy OS 200 will receive an acknowledgement from the state save process that indicates when contents of a buffer have been copied to mass storage device(s) 248 for state save purposes. At this time, legacy OS may use the Release function to release the memory area containing the buffer that stores the copy of the memory contents. The Delay flag need not be activated for this Release function, since the allocated buffer contains only a copy of the recovered data, and is not the original buffer. In contrast, the recovered memory buffer is released in a deferred manner, as set forth in the foregoing paragraph.

Legacy OS cannot issue the Recovery Complete function until legacy OS has received an indication that the state save function has completed successfully for each memory bank that is to be recovered and saved in the above-described manner. This ensures that SCS 204 retains a copy of all data that is to be saved until the state save operation successfully completes. Otherwise, data may be lost if the state save operation or some other aspect of the recovery does not complete successfully.

The embodiment described above recovers a memory bank, and then copies the contents of that memory bank to a newly-acquired buffer. In an alternative embodiment, it is possible for legacy OS to create an entry on state save queue 226 that references the address of the recovered memory bank rather than the copy thereof. The state save operation would occur directly from the recovered memory bank. This eliminates the need to perform the copy operation. In this alternative embodiment, legacy OS will not release the recovered memory bank until the state save operation for that bank is completed. The release will occur using the Release function with the Delayed flag set, as was the case in the former embodiment.

After legacy OS receives an indication that the state save operation completed for each memory bank that was queued to state save queue 226, legacy OS will issue the Recovery Complete function to SCS 204. SCS may then release all banks on the state save queue 226, including any bank allocated during this boot session for use during a Recover function to recover data from state save fillies 252.

The above discussion provides several alternative ways to handle memory that was allocated to a previous boot session. In a first case, the originally-allocated memory banks are merely discarded. In another case, the contents of originally-allocated memory banks are the target of a state save operation that is completed before the memory bank is discarded. In yet another case, some of the banks may be saved and discarded, and others may be merely discarded.

As discussed above, legacy OS 200 determines which memory banks to save using controls bits associated with each bank. In one embodiment, the control bits are flags that are retained in the corresponding session data. These flags may be set on a bank-by-bank basis, and/or may be set on a domain basis. For instance, it may be determined that all memory banks allocated to a particular domain as recorded in DLT 306 must be the object of a state save operation if a re-boot occurs. In one implementation, the domain flags, which are maintained in the DLT 306, may override any other flags that are bank-specific. According to another aspect of the invention, the state save flags are only used if one or more “boot keys” indicate state saves operations are to occur. The boot keys are operator-selected designators that are used to control various aspects of the system. These boot keys may be saved within the session data. If the boot keys indicate no state save operations are to occur, the state save flags contained within the session data are ignored.

In the embodiment described above, the state save flags are retained by legacy OS 200 in the session data. SCS 204 may likewise retain state save flags. Recall that when legacy OS 200 uses the Acquire function to acquire memory, word 4 of the packet for this function contains attribute flags. These attributes may likewise be set after memory is allocated using the Set Attribute function. One of these flags is the state save flag that is assigned to those memory banks that are to be the target of a state save operation.

The SCS 204 may create a state save file if a failure occurs before Recovery Start time. That is, as SCS is processing each entry on the acquire queue 224, if the entry is associated with a memory bank that has the state save flag set, the contents of the memory bank can be saved to mass storage 108. Once the bank has been saved, a request is issued to commodity OS 110 to release that bank. This capability is useful to save the state of memory banks during time sequence 400. It may be noted that these state save files are located in mass storage devices 108 for the commodity OS whereas the legacy OS 200 state save files are stored in legacy OS mass storage devices 248.

Yet another kind of state save process may be initiated, as was previously described in regards to recovery processing. This involves the situation wherein a critical failure affects operation of commodity OS 110 such that its operation must be halted and a cold boot initiated. In this case, before commodity OS halts, it will save the state of the entire system to state save files 252 on mass storage devices 108. If this type of failure occurs, during subsequent recovery processing initiated for legacy OS according to FIG. 4, data is read from state save files 252 when a Recover function is used. The recovered data may then be stored to one of the state save files 230 on mass storage devices 248 so that it becomes available for analysis during the state save process to be described below.

In each of the three types of state save scenarios discussed above, data is saved to a respective one of state save files 230, 250, and 252 along with an indication of the address at which the saved data was stored. For instance, for each predetermined block of data that is stored to a state save file, the address at which this data resided within main memory 100 is stored along with that data portion. In one embodiment, this address is retained in a header stored along with the data. This address may then be used to re-create the execution environment of system 201. According to one aspect of the invention, the address that is stored along with the data is a virtual address that is used to recreate the virtual address space of system 201 so that analysis may be performed, as will be discussed in detail below.

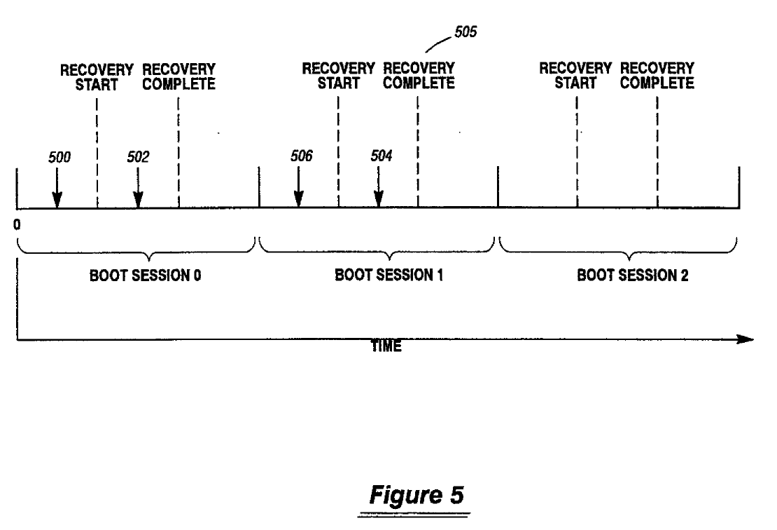

The foregoing describes a method for performing recovery in a manner that eliminates the occurrence of memory leaks. Various recovery scenarios according to the current method may be considered in reference to FIG. 5, as follows.

FIG. 5 is a timeline that represents multiple successive boot attempts for legacy OS according to the current invention. Boot sessions 0, 1, and 2 occur during successive time intervals. Each such interval includes a recovery start and complete time corresponding to the time at which legacy OS issues the Recovery Start and Recovery Complete functions, respectively. Various recovery scenarios are described in regards to this timeline.

First, assume a failure occurs at time 500 during boot session 0. At this time, the session data 0 has not yet been completely constructed. Therefore, SCS 204 is responsible for releasing all acquired memory prior to the initiation of boot session 1. Therefore, when boot session 1 is initiated, and assuming recovery start time is reached, legacy OS will not have any prior session data to process or recover. A “null” pointer will be stored as the session data pointer of the RBA for session 0. Therefore, legacy OS will issue the Recovery Start function and the Recovery Complete function in a “back-to-back” manner without the need to perform any interim processing.

Next, assume a failure instead occurs at time 502 during boot session 0 after legacy OS issues the Recovery Start function. As a result, SCS 204 initiates boot session 1. Assuming the recovery start time for boot session 1 is reached. Therefore, legacy OS 200 obtains the address for the session 0 RBA from SCS 204 and performs memory recovery in the manner described above. If this completes successfully, the session data for boot session 1 will store a Null pointer in the pointer to the previous session data.

Next, assume that during recovery of session 0 data, a second failure occurs at time 504 prior to recovery complete time 505. SCS 204 therefore initiates boot session 2. If recovery start time is reached during boot session 2, legacy OS obtains the pointer to the RBA for session 1 data. Legacy OS must perform recovery operations for both session 1 data and session 0 data.

Consider yet another scenario wherein a first failure occurs at time 502 during boot session 0. Because of this failure, legacy OS enters boot session 1. Recovery start time for boot session 1 is not yet reached at the time legacy OS experiences another failure at time 506. SCS 204 therefore recovers all memory associated with boot session 1, and legacy OS enters boot session 2. If recovery start time is reached this time, legacy OS must now perform recovery for session 0 but not session 1, since memory associated with session 1 was recovered by SCS 204 prior to the start of boot session 2. The memory allocated during boot session 0 is considered the responsibility of legacy OS since recovery start time was reached during boot session 0 before the failure occurred.

As may be appreciated from FIG. 5 and the associated examples, an almost infinite number of recovery scenarios are possible according to the current invention.

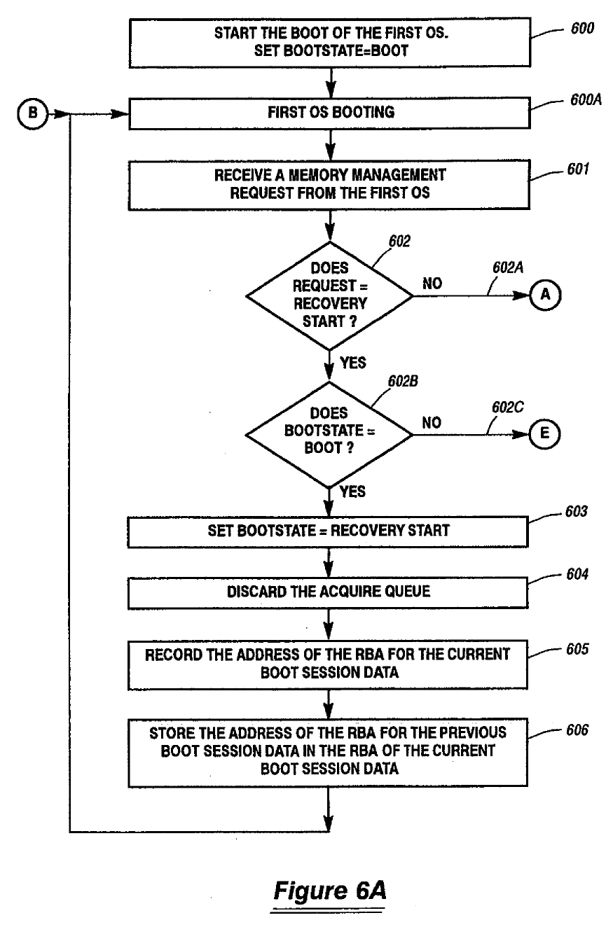

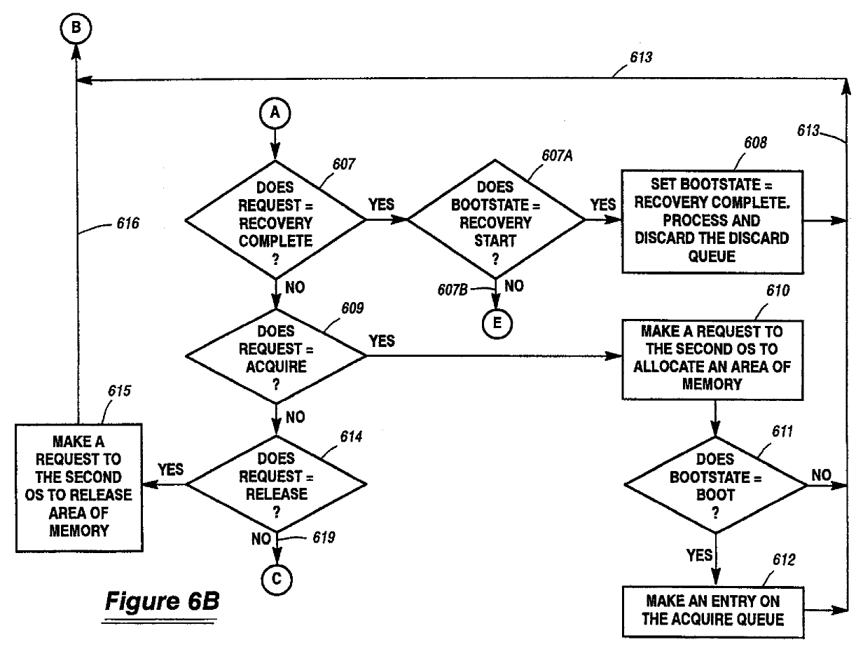

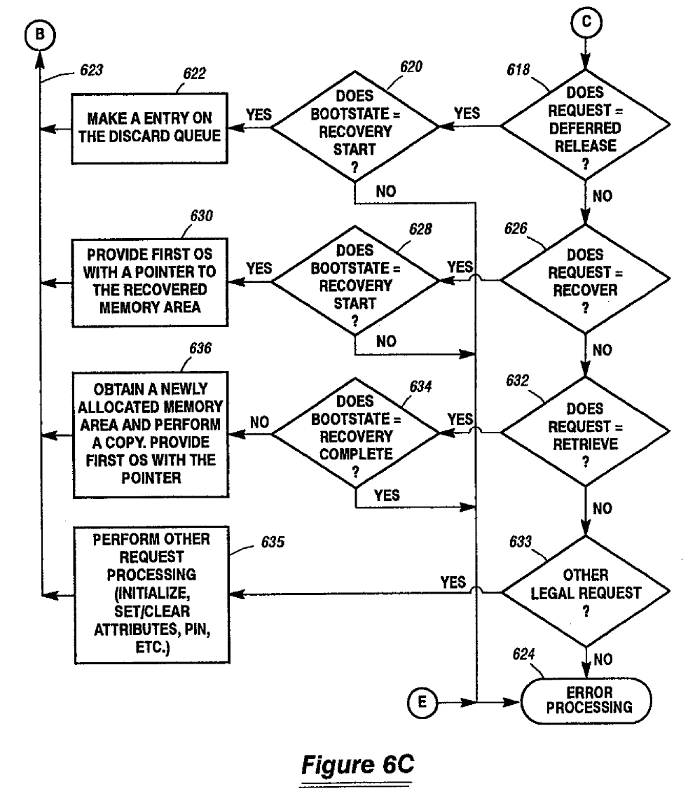

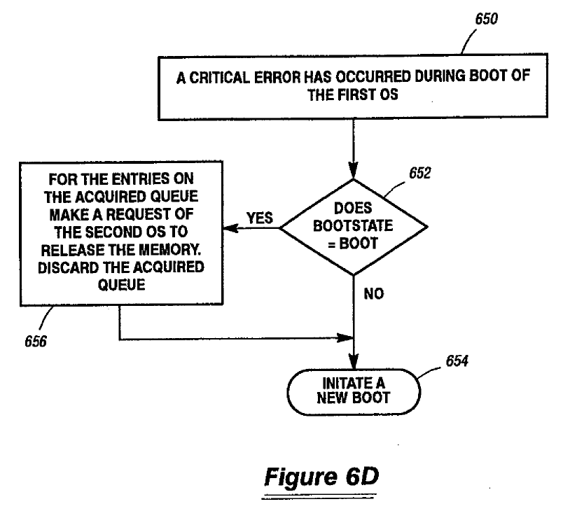

FIGS. 6A, 6B, and 6C are a flow diagram of one method of booting an operating system according to the current invention. In one embodiment, this method is executed by SCS 204 during a re-boot of the legacy OS.

The diagrams of FIG. 6A-6C refer to a SCS BootState variable that corresponds to the timeline in FIG. 4. If this BootState variable is set to “Boot”, processing is occurring within time interval 400 of FIG. 4. If the BootState variable is set to “RecoveryStart”, processing is occurring within time interval 404. If the BootState variable is set to “RecoveryComplete”, processing is occurring after the Recovery Complete time 406.

The method of FIGS. 6A-6C is initiated by starting execution of a first OS on the system which may be similar to that of FIG. 2 (600). At this time, the BootState variable is set to “Boot”. According to the implementation described above, this first OS is legacy OS 200.

Once booting of the first OS is initiated, SCS 204 is in a state wherein it waits for requests from the first OS and monitors the system for error conditions. This state is represented by block 600A of FIG. 6A. Requests will be received when the first OS executes the IPC instruction with one of the functions described herein selected. The receipt of such a request is represented by step 601.

One of the request types issued via execution of the IPC instruction may indicate that recovery is being started (602). In one embodiment, this type of request is issued when the Recovery Start function is selected during IPC instruction execution. When SCS 204 detects this type of request, it is first determined whether the BootState variable is set to “Boot” (602B). If the Recovery Start function is selected at any time other than when the BootState variable is set to “Boot” (for example the Recovery Start function is issued during time period 404 of FIG. 4), an error occurs. If such an error occurs, processing proceeds to step 624 of FIG. 6C, as indicated by arrow 602C. Otherwise, processing continues to step 603 where the BootState variable is set to “RecoveryStart”.

Recall that the Recovery Start function is issued to mark time 402 of FIG. 4. At this time, SCS 204 may discard the acquire queue 224, since it will now be the responsibility of the legacy OS 200 to recover any memory that was allocated on the legacy OS' behalf during this boot session (604). The address of the RBA for the current boot session data may be recorded (605). For example, the SCS 204 may record this address in a predetermined memory location so that it is available to be stored in the session data pointer field of the RBA for the next boot session. Additionally, the address of the RBA for the previous boot session data may be stored in the RBA of the current boot session data (606). This creates the linked list that is described in reference to FIG. 3. Processing may then return to block 600A as the booting of the first OS continues.

Returning to decision step 602, if the request is not a Recovery Start request, processing continues to FIG. 6B, as indicated by arrow 602A. There, decision step 607 is executed to determine if the received request is a Recovery Complete request. Recall that this type of request occurs when the IPC instruction is executed with the Recovery Complete function selected.

If a Recovery Complete request was received, it is next determined whether the BootState variable is set to “RecoveryStart” (607A). If the Recovery Complete function is selected at any time other than when the BootState variable is set to “RecoveryStart” (as may occur, for example, if the Recovery Complete function is erroneously issued during time period 400 of FIG. 4), an error occurs. If such an error occurs, processing proceeds to step 624 of FIG. 6C, as indicated by arrow 607B. Otherwise, if an error does not occur in step 607A, processing continues to step 608. There, the BootState variable is set to “RecoveryComplete”.

The setting of the BootState variable to “RecoveryComplete” corresponds to recovery complete time 406 of FIG. 4. At this time, the discard queue is processed and discarded (608). Processing of the discard queue involves making a request to a second OS, which in one embodiment is Linux, to release an area of memory associated with each entry on the discard queue. A request is then made to the second OS to discard the memory allocated for the discard queue itself. This allows all releasing of memory during time period 404 to occur in a deferred manner, as discussed above. When this processing is complete, execution returns to block 600A of FIG. 6A, as indicated by arrow 613.

Returning to decision step 607, if the request is not a Recovery Complete request, processing continues to step 609, where it is determined whether the request is an Acquire request. If so, a request is being made to acquire memory. In response, SCS 204 makes a request to the second OS to allocate an area of memory (610). Next, it is determined whether SCS must track the allocation of this memory. In particular, if the BootState variable is set to “Boot”, indicating that execution is occurring within time period 400 of FIG. 4 (611), an entry is made on the acquire queue to record the allocation of this memory (612). Processing then returns to block 600A of FIG. 6A, as indicated by arrow 613. If the BootState variable is not set to “Boot”, processing may merely return to block 600A of FIG. 6A without making a record of the memory allocation, since the first OS is at a point in the boot process where it is responsible for retaining this record on its own behalf.

In decision step 609, if the request is not an Acquire request, execution proceeds to decision step 614. There, if the request is a Release request, a request is made to the second OS to release a specified area of memory (615), and processing returns to block 600A of FIG. 6A, as represented by arrow 616. A release request may be used to release memory substantially immediately without deferred processing. This may be done to release memory that was allocated during the current boot session, and which is no longer needed.

If the request is not a release request, execution continues to step 618 of FIG. 6C, as indicated by arrow 619. In step 618, if the request is a deferred release request, as is issued by executing the IPC instruction with the Release Function selected and the Deferred Flag activated, it is determined whether the BootState variable is set to “RecoveryStart” (620). If so, the area of memory to be released, as indicated by the release request, is added to the discard queue (622). Processing then returns to book 600A of FIG. 6A, as indicated by arrow 623.

Returning to decision step 620, if a deferred Release request was received and the BootState variable is not set to “RecoveryStart”, an error occurred such that execution continues to error recovery block 624. This error occurred because the deferred Release request should only be issued during time period 404 of FIG. 4. The error recovery procedures are discussed further below.

Returning to step 618, if the request is not a deferred Release request, execution continues to step 626 where it is determined whether the request is a Recover request. If so, execution proceeds to step 628, where it is determined whether the BootState variable is set to “RecoveryStart”. If it is, the first OS is provided with a pointer to a recovered memory area containing data from a previous boot session (630). This memory area may be used to perform a state save operation, as discussed above. Then execution returns to block 600A of FIG. 6A, as represented by arrow 623.

If, in step 628, the BootState variable is not set to “RecoveryStart”, a Recover request should not have been issued. Therefore, an error occurred, and execution continues to block 624, where error processing will occur in a manner to be described below.

Returning to decision step 626, if the request is not a Recover request, processing continues to step 632, where it is determined whether the request is a Retrieve request. If so, and if the BootState variable is not set to “RecoveryComplete” (634), processing proceeds to step 636. There, a newly-allocated memory area is obtained and a copy operation is performed to transfer data into this memory area. A pointer to this memory area is then provided to the first OS. Processing may then return to block 600A of FIG. 6A, as indicated by arrow 623.

In step 634, if the Retrieve function was received but the BootState variable is set to “RecoveryComplete”, an error occurred. This is so because a Retrieve request is only to be issued before the recovery complete time 406 of FIG. 4 or an error occurred. If such an error occurred, processing proceeds to block 624 for error recovery processing.

Returning to step 632, if the request is not a Retrieve request, one of the other types of instructions listed in Table 2 may have been received. Such functions include the Set/Clear Attribute, Initialize, and Pin functions. If such requests are received (633), processing for the request is performed (635) and execution returns to block 600A of FIG. 6A. Otherwise, if in step 633 the received request does not include a legal function, error processing is initiated (624).

The type of error processing that is performed will depend on the implementation and/or the type of error that occurred. In one embodiment, the processing merely involves rejecting the request, which was issued by the first OS at an inappropriate time during the boot process. Other actions may be taken in addition, if desired, such as reporting the error. After this type of error processing completes, execution may return to the main request receiving loop at block 600A of FIG. 6A, as indicated by arrow 623.

In some cases, error processing 624 may determine that a received error is of a critical nature. In this case, processing occurs according to FIG. 6D as follows.

FIG. 6D is a flow diagram that illustrates the method that is executed if a critical error occurs any time during the booting of the first operating system, as illustrated by FIGS. 6A-6C (650). In this case, it is determined whether the BootState variable is set to “Boot” (652). This indicates processing is occurring within time period 400 of FIG. 4. If so, execution continues to step 656 where, for each entry on the acquire queue 224, a request is made to the second OS to release the memory associated with the entry. A request is then made to the second OS to discard the memory allocated to store the acquire queue itself. A new boot may then be initiated (654).

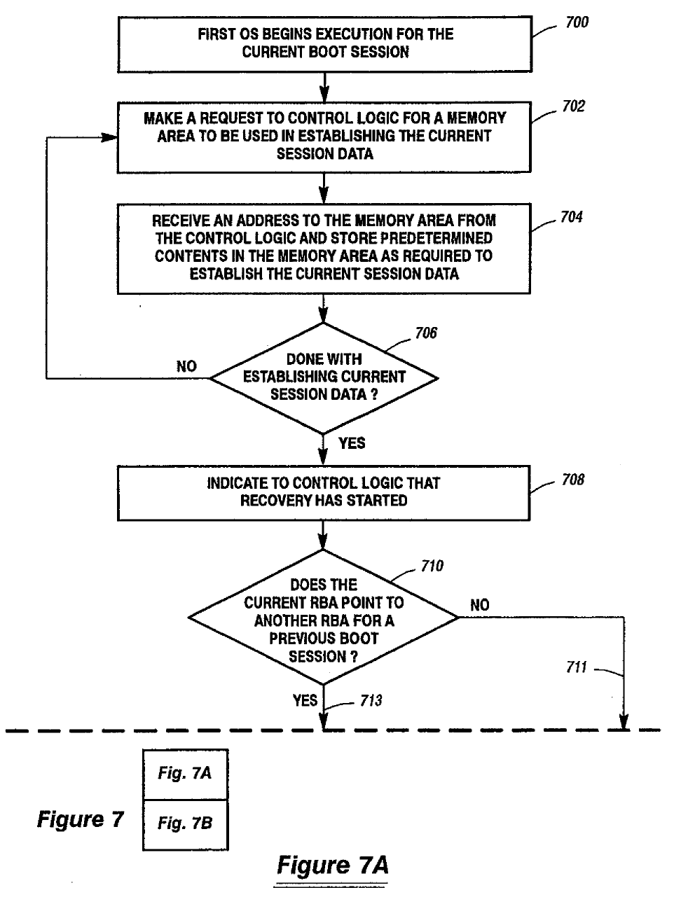

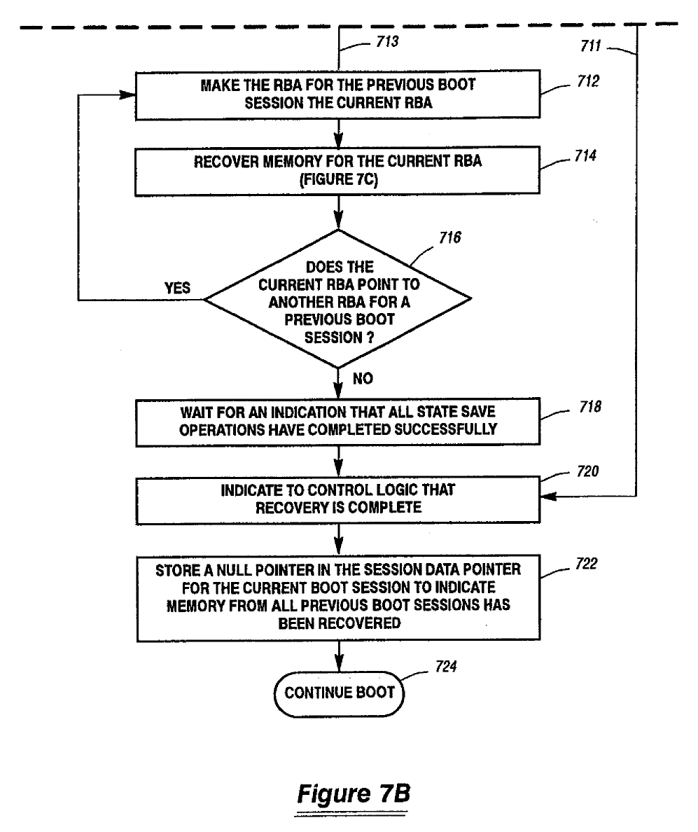

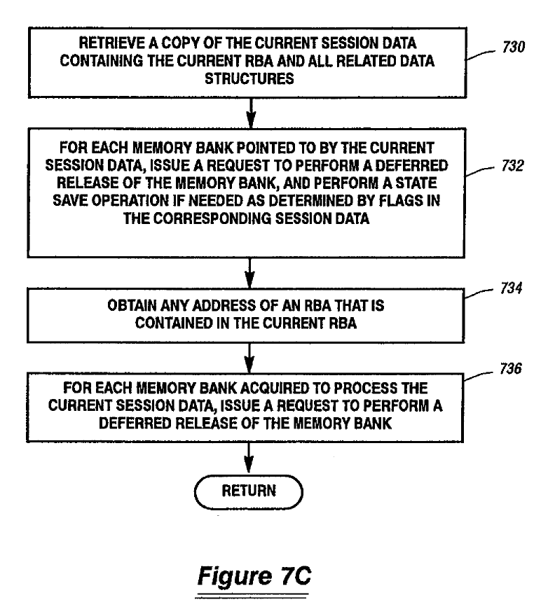

FIGS. 7A and 7B, when arranged as shown in FIG. 7, are a flow diagram of another process according to the current invention. In one embodiment, this process is executed by legacy OS 200 executing on a commodity platform such as is shown in FIG. 2. The first OS, which in the current embodiment is the legacy OS 200, begins execution for a current boot session (700). This OS makes a request to system control logic 203 for a memory area that is to be used to establish the current session data for the current boot session (702). The address for the memory area is received from the control logic. In a manner largely beyond the scope of this invention, predetermined data structures are created and initialized within this memory area as required to establish the session data for the current execution environment (704).

Next, if the current session data has been established (706), an indication is provided to the system control logic 203 that recovery is started (708). In one embodiment, this involves executing an IPC instruction with the Recovery Start function selected. It is then determined whether the current Recovery Bank Area (RBA) included within the session data for the current boot session points to another RBA for a previous boot session (710). If not, execution continues to step 720 of FIG. 7B as shown by arrow 711. There, an indication is provided that recovery is complete, as may be accomplished by executing the IPC instruction with the Recovery Complete function selected. A null pointer may now be stored within the session data pointer of the current boot session to indicate memory allocated to all previous boot sessions has been recovered (722). Then the boot process may be continued in a manner largely beyond the scope of the current invention (724). Additional processing that is performed after this time involves tasks such as setting up files that will be utilized by legacy OS 200 to support the execution environment for application programs 208, for instance. When this processing is completed, legacy OS 200 is ready to begin accepting requests.

Returning to step 710 of FIG. 7A, if the current RBA points to another RBA for a previous boot session, processing continues to step 712 of FIG. 7B, as indicated by arrow 713. There, the RBA for the previous boot session is made the current RBA. The memory in the current RBA is then recovered according to the process of FIG. 7C (714). It is then determined whether the current RBA points to another RBA for a previous boot session (716). If so, processing returns to step 712 so that steps 712 and 714 may be repeated.

If, in step 716, the current RBA does not point to another RBA, the current RBA is the last RBA in the linked list. Therefore, processing waits for an indication that all state save operations have completed successfully. That is, all memory banks that were represented by an entry on state save queue 226 must have been stored successfully to retentive storage on mass storage devices 248 (718). After this is completed, an indication may be provided that recovery is complete (720). In one embodiment, this occurs by executing the IPC instruction with the Recovery Complete function selected. A null pointer may now be stored within the session data pointer field 307 of the session data for the current boot session (722). Then booting may continue in a manner largely beyond the scope of the current invention (724).

FIG. 7C is a flow diagram that illustrates processing performed to recover the memory associated with an RBA, as referenced in regards to step 714 of FIG. 7B. A copy of the session data for the current RBA is retrieved (730). For each memory bank pointed to by the session data that was most recently retrieved, a request is issued to perform a deferred release of the memory bank, with a state save operation being requested as needed (732). In one embodiment, the banks for which a state save is to be performed is indicated by flags maintained within the session data for the current session.

Next, an address for a next most recent session's RBA, if any, is retrieved from the current RBA (734). Any memory bank that was newly acquired to process the current RBA may then be released (736). In one embodiment, this will include the memory banks acquired to store the retrieved copy of the session data that is currently being processed. This may also include memory banks that were used to process recovered data that was no longer available in virtual address space. This release may be accomplished using the Release function with the Delayed flag set. Processing then returns to FIG. 7B, where execution proceeds to step 716.

The above description focuses on the recovery operation used to synchronize disparate operations so that memory leaks do not occur. Often times this process can be aided by determining why the boot process failed in the first place. By evaluating and addressing the fault situations, the need to recover and release memory may be minimized, thereby minimizing the opportunity for the creation of memory leaks.

Evaluation of faults is aided by the state save process described above. This involves storing the contents of memory banks to mass storage devices 248 based on the state of state save flags. Each memory bank may be associated with a respective flag that indicates whether that bank is to be saved during recovery processing. Other domain-specific flags may be used to determine whether all banks for a given domain are to be saved, as discussed above. Additionally, state save keys may be set to a predetermined state by an operator to indicate whether a state save should be performed. The state save keys take precedence over the state of the flags.

State Save Analysis

If a state save operation occurs during a re-boot operation, the contents of the saved memory banks that are created by legacy OS 200 are stored as state save files 230 (FIG. 2) on mass storage devices 248. In the rare case wherein a boot occurred during time period 400 of FIG. 4, one or more state save files 250 may also be stored on mass storage devices 108. These state save files 250 are created by SCS 204 as opposed to being creating by legacy OS 200.

In addition to state save files 230, which are created by legacy OS 200, and state save files 250, which are created by SCS 204, a third type of state save file may be created within the system of FIG. 2 in the manner described above. These are shown as commodity OS state save files 252. These files are created when a critical fault occurs on the data processing system, thereby causing commodity OS 110 to fail. In this case, commodity OS will save its state to state save files 252 on mass storage devices 108 before the commodity OS stops execution. Memory included in these state save files may be recovered by legacy OS using the Recover function. In such cases, some of the data initially included within state save files 252 that described one or more execution states of legacy OS 200 from one or more previous boot sessions is incorporated into state save files 230.

State save files 230 and 250 contains data that primarily describes the legacy OS′ execution state. These files may be transferred to analysis system 234, which is a system that is adapted for analyzing legacy OS′ execution state. In contrast, state save files 252 are not dedicated to storing information on legacy OS′ execution state, but instead contain data describing the state of the entire system at the time a fault occurred. These state save files 252 therefore contain a large amount of data that is beyond the scope of the current invention. For this reason, most of the data contained within state save files 252 is not generally transferred to analysis system 234 for analysis, but is reviewed in some other manner. Only selected portions of state save files 252 that are recovered via the Recover function and thereafter saved to state save files 230 will be analyzed by analysis system 234.

Analysis system 234 may be located at a same, or a different, site relative to the original data processing system 201. In one implementation, the state save files are transferred to analysis system via a communication link 232, which may be a “wired” or a wireless connection. The files may be transferred using a Transmission Control Protocol/Internet Protocol (TCP/IP) protocol, a File Transfer Protocol (FTP), or any other type of suitable communication protocol.

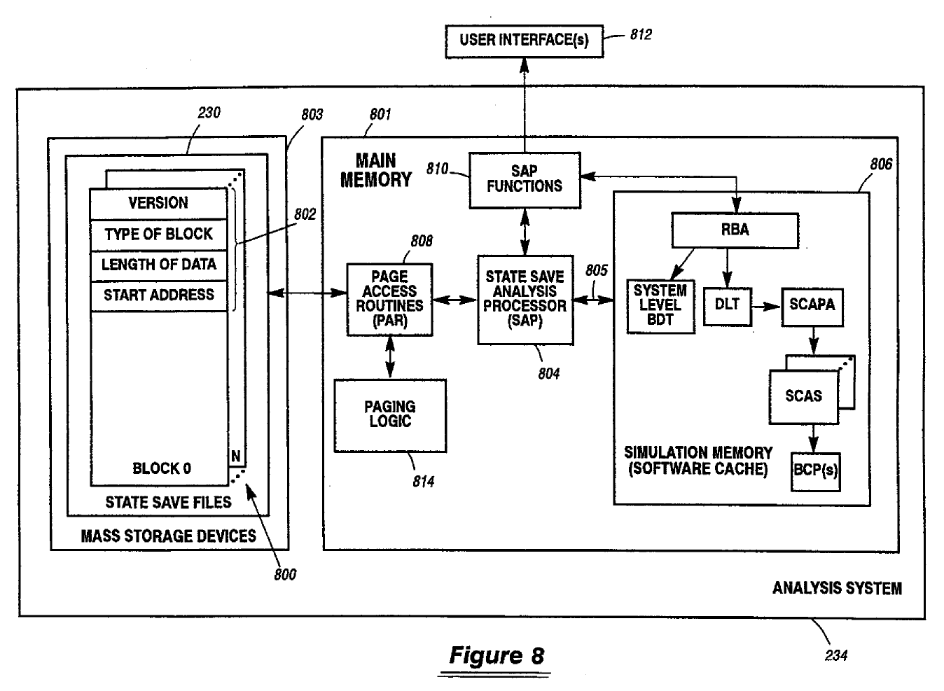

Once the files are resident on the analysis system 234, they are reconstructed and analyzed using a state save tool as discussed in reference to FIG. 8.

FIG. 8 is a block diagram of an analysis system 234 used to analyze state save files. This analysis system is a data processing system that may be similar to that shown in FIG. 2. That is, it may include a main memory 801, one or more caches, and one or more instruction processors (not shown). The main memory may be coupled to one or more mass storage devices 803.

State save files 230 may be transferred from the system from which they were capture (i.e., “target system”) to storage devices of analysis system 234. In the embodiment shown in FIG. 8, these files are transferred to mass storage devices 803. In another embodiment, the files could be transferred to main memory 801 of the analysis system 234 if the memory of the analysis system were large enough.

According to one implementation, the state save files include multiple blocks, shown as blocks 0-N 800 of FIG. 8. Each block may include the contents of one or more memory banks saved from the target system. In one embodiment, these blocks are not necessarily stored in any order that corresponds to the virtual addresses represented by the blocks. For instance, assume a first block contains data for virtual addresses 0-1000, and an Nth block contains data for virtual addresses 1001-2000. These blocks need not be stored contiguously in state save files 230. Moreover, the first block need not be stored before the Nth block. This lack of storage restrictions allows the state save files to be created much more quickly by legacy OS 200. However, this provides challenges when retrieving the data, as will be described below.

Each block includes a header 802 with various fields describing the contents of the block. One field may provide a version, which indicates the version of the block format. If changes to the state save data require the addition or removal of fields within some of the blocks, the analysis system 234 may use the version field to interpret the various block formats.

A type field may also be provided. For instance, the type may indicate that the block stores a memory bank that was allocated to legacy OS 200 for use in storing its execution environment. As another example, the block may contain a code bank that stored instructions for one of APs 208. Alternatively, the block may contain a data bank used by one of APs 208.

Header 802 may further contain fields indicating the length of data stored within the block, as well as the starting address of the block. In the current embodiment, this starting address is the virtual address at which the block resided in virtual address space on the target system.

A State Save Analysis Processor (SAP) 804 is loaded into the main memory 801 of, and executes on, the analysis system. In one embodiment, the SAP processor is a software application. However, in a different embodiment, part or all of the SAP may be implemented in hardware. SAP 804 controls retrieval of the blocks of the state save files 230. The SAP also controls the reconstruction of the session data and other memory banks for the one or more boot sessions that are described by the retrieved state save blocks. This reconstructed data is retained within simulation memory 806, which is allocated to SAP 804 by analysis systems 234. In one embodiment, simulation memory 806 is a software cache, as will be discussed further below.

The reconstruction of the session data within simulation memory 806 occurs as follows according to one implementation of the invention. SAP functions 810 initiate retrieval of a predetermined block from the state save files 230. This may be a block from a predetermined location within the state save files 230 (e.g., the first block of a first file). Alternatively, this block may be that having a predetermined virtual address stored in the “start address” field of its block header 802. In either case, the execution of SAP functions 810 cause SAP 804 to communicate to the page access routines (PARs) 808 that this block is to be retrieved from the state save files 230.

The PARs 808 are routines that are responsible for retrieving blocks from the state save files. Generally, SAP 804 will pass PARs 808 the virtual address for the block that is to be retrieved. This virtual address is the address stored within the “start address” field of a block header. PARs 808 will first determine whether this block was previously retrieved from the state save files 230. This is accomplished by making a call to paging logic 814. If the block was previously retrieved, paging logic 814 passes the block's location within state save files 230 so that this block may be retrieved directly without the need to perform a search. If, however, the block was not previously retrieved, PARs 808 must perform a linear search of all of the blocks in the state save files 230 to locate the block having a header containing the specified starting address in its “start address” field.

Once the specified block is retrieved, this block is transferred into simulation memory 806. If this was the first time this block was retrieved, PARs 808 provides to paging logic 814 the location within state save files at which the block was retrieved. Paging logic records this location for use later if the block is transferred out of simulation memory because simulation memory becomes full. This is discussed further below.

After a block that is retrieved from the state save files 230 is stored within simulation memory 806, it may be used by SAP 804 to retrieve additional blocks from state save files. This is possible because SAP functions “understand” the format of the session data construct (one embodiment of which is shown in FIG. 3). SAP functions are therefore able to retrieve pointers from the appropriate fields within this session data. For example, after a predetermined block containing an RBA has been stored within simulation memory 806, SAP functions are able to retrieve addresses pointing to the system-level BDT 304, the DLT 306, and any other pertinent data structures.

Once a SAP function has retrieved an address pointing to another construct that is to be retrieved, SAP passes this address to PARs 808 for retrieval in the manner described above. The retrieved block is passed to SAP to be stored in simulation memory 806. In this manner, some or all of the session data may be reconstructed within simulation memory 806.

After at least a portion of the session data has been reconstructed, other memory buffers (e.g. memory banks 311 and/or memory buffers 210) may likewise be retrieved using pointers from the session data. The content of these buffers (code and/or data) may be recovered so that all data constructs of interest are eventually recreated within simulation memory 806.

As may be appreciated, the reconstructed data is no more than a very large memory area containing “ones” and “zeros”. A system analyst viewing data in this format would have a difficult time interpreting this information. Therefore, SAP functions 810 interpret this data and place it into a much more “user-friendly” format that may be displayed via user interface(s) 812, which may include a printer and/or a display screen.

SAP functions 810 “understand” the format of session data. SAP functions 810 are therefore able to access the various constructs contained within simulation memory 806 and provide those constructs to a user in a table or other similar format that includes ASCII headers and text that explains what a user is viewing. The data itself may be provided in a selected format, such as binary, hexadecimal, octal, and so on.

As an example, a user of user interface(s) 812 may indicate that he or she wishes to view the RBA of a particular boot session. In response, SAP functions 810 retrieve the contents of the RBA for the specified boot session from simulation memory 806 and provide those contents to the user in a user-friendly format. As discussed above, the format may include ASCII labels for each of the fields followed by the data in a specified format. As an example, one display may include the following information, with data in hexadecimal format:

Recovery Bank Area: Session 1
System Level BDT for Boot Session 1: 400000000H
Domain Lookup Table: 700000000H
Session Data Pointer for Boot Session 0: 39FF80000H

An RBA will contain large amounts of data, some or all of which is labeled with a corresponding label in the manner exemplified above.

In one embodiment, the user interface(s) include a Graphical User Interface (GUI) that allows a user to easily traverse between the various constructs that have been reconstructed within simulation memory. For instance, the label “System Level BDT for Boot Session 1” appearing in the exemplary display set forth above may be link. When a user selects this link with his cursor or another input device, the SAP functions 810 cause the addressed memory banks to be located and retrieved from simulation memory 806, or if necessary, state save files 230. The data contained within this structure may then be displayed for the user and the process repeated. “Back” and “Forward” functions available on many GUI interfaces may be provided to return to previously-viewed screens. These mechanisms allow the user to quickly traverse between the interconnected structures of the session data so that the operating environment that existed during a particular boot session may be viewed and readily comprehended.

Using the session data pointer contained within a RBA, a user may further traverse to the session data for one or more previous boot sessions. This may help a user determine whether a pattern exists, such as a failure that is always occurring when a particular type of operation is underway.

The user interface(s) 812 provide a mechanism whereby a user may request the contents of any virtual address represented by the state save files 230. If the requested contents are not currently loaded into simulation memory 806, SAP 804 operates in conjunction with PARs 808 to process the request so that the requested block(s) are retrieved from state save files 230 and loaded. The contents may then be provided to the user.

In most cases, when a user provides a request to view the contents of an address, the request contains a virtual address. This corresponds to the virtual addresses contained within headers 802. However, a user may optionally specify that the provided address is a real address. In this case, SAP functions 810 or SAP 804 converts this physical address into a virtual address using the virtual-to-physical memory mapping that had been in use at the time the session data was created. This memory map is contained within the session data reflected by state save files 230 and simulation memory 806, and is therefore available to SAP functions for use in performing this physical-to-virtual address conversion process.

The foregoing describes a system wherein at least some of the blocks included within state save files are reconstructed within simulation memory 806, and then the user may begin viewing the contents of requested ones of these blocks. For example, generally at least the memory map contained within the session data is reconstructed in simulation memory 806 before SAP functions 810 begins receiving requests from users. In another embodiment, a user of user interface(s) 812 is allowed to specify via those interfaces which memory areas are to be viewed. For instance, a menu on a GUI interface may allow a user to indicate that he or she wants to view the contents of the system level BDT and the SCAPA for a given session. Upon receipt of this request, SAP functions 810, via SAP 804, will only initiate, via PARs 808, retrieval of those areas that are needed to obtain the data requested by the user. This allows the user to begin viewing the contents of data with a minimal amount of delay.

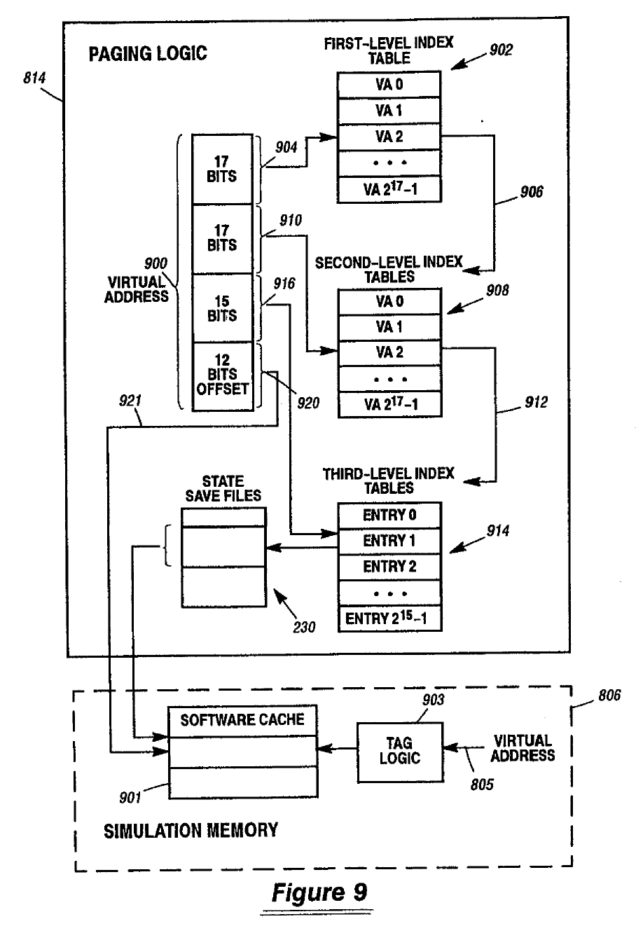

One of the challenges associated with the use of a simulation memory 806 as shown in FIG. 8 is that the size of this memory is much smaller than the size of the virtual memory space of the target system. For instance, in one embodiment, the virtual address space of the target system is described using a 61-bit C pointer, and therefore may be 261 words in length. According to one embodiment, this challenge is addressed using paging logic 814 and a software cache. This is described further in reference to FIG. 9.

FIG. 9 is a block diagram of the paging logic 814 according to one embodiment of the invention. According to this embodiment, SAP 804 provides a virtual address on interface 805 to simulation memory 806 (shown dashed in FIG. 9), which is implemented as a software cache 901 and corresponding tag logic 903. In one embodiment, the address provided to simulation memory 806 is a 61-bit C pointer.

Software cache 901 is divided into multiple cache blocks, each of which may store a predetermined number of the blocks from the state save files 230. Tag logic 903 records the start addresses for the state save file blocks that are stored within each of the cache blocks at a given time.

When an address is provided to simulation memory 806, tag logic 903 applies a hash function to the address. The results of this hash function selects one of the blocks of the software cache. An entry within tag logic 903 that corresponds to the selected cache block is referenced to determine whether the requested state save block is already resident within the cache block. If so, the contents of the state save block may be read from the software cache and presented to the user. Otherwise, the state save block must be retrieved from state save files 230.

As discussed above, the blocks of a state save file 230 need not be arranged in any order that corresponds to the virtual addresses represented by the blocks. This arrangement is selected because it allows legacy OS 200 to save data more quickly and efficiently when a state save file 230 is created. This type of mechanism is in contrast to prior art analysis systems, which store saved data in a manner that does correspond to addresses. Such prior art systems increase the amount of time required to create the files.

Because the current system does not store the data blocks in any order that may be determined by the virtual addresses, a virtual address cannot be used to determine which block of the state save files 230 contains the addressed data. Therefore, when a virtual address is being used for the first time to retrieve data from state save files 230, the only way to initially locate the block of data corresponding to this address is to perform a linear search of all blocks in the state save file. Once the requested block is located in this manner, the location of this block is retained in paging tables. In FIG. 9 these paging tables are shown as the first-level, second-level, and third-level index tables 902, 908, and 914, respectively. These tables are used as follows.

When a block is to be retrieved, the tables contained in paging logic 814 are referenced to determine whether the requested state save block was previously retrieved from the state save files 230. To do this, the virtual address is divided into four portions, as shown in block 900. A first-level index table 902 is referenced by a first portion of the virtual address. In one implementation, this first-level index table includes 217 entries, one of which is selected by the 17-bit portion 904 of the virtual address.

Each entry in the first-level index table stores a pointer. Each pointer points to one of the second-level index tables 908. Up to 217 different second-level index tables may be created according to this embodiment.

Next, address portion 910 of the virtual address is used to select an entry from the second-level index table that was chosen via pointer 906. As may be appreciated, because address portion 910 includes 17 bits, each one of the second-level index tables may include up to 217 entries.

Each entry of each of the second-level index tables 908 stores a pointer. Each pointer points to one of the third-level index tables 914. Up to 217 different third-level index tables may be created according to this embodiment.

Address portion 916 of the virtual address is used to select an entry from the third-level index table that is identified by pointer 912. This fifteen-bit field may select any one of up to 215 entries. If the requested state save block has been retrieved from the state save file at least once during the current analysis session, the contents of this selected entry will be set to point to the location within state save files 230 that contains the requested block of state save data.

If the requested state save block has never been retrieved during this state save session, the located entry within the third-level index tables 914 will be set to some initialization value, such as “0”. In this case, paging logic 814 conducts a linear search of state save files 230 to locate the block that has, as its start address in the start address field of header 802, the virtual address represented by address portions 904, 910, and 916 of FIG. 9. The location of this block within the state save files is then recorded within the corresponding entry of the third-level index tables 914. This information is now available for use if that same state save block must be retrieved from state save files again in the future.

Next, the contents of the block are loaded into the block of the software cache 901 that was selected by the hashing function of tag logic 903, and the tag logic is updated to record that this block is now resident in cache. Finally SAP 804 adds the offset 920 to the block address to access the addressed data word within the block, as shown by arrow 921. In one embodiment, this offset is used to access a selected 36-bit data word, which is the word size utilized by the legacy platform to which legacy OS 200 is native. This accessed data is used or displayed by the one of SAP functions 810 that initiated the request.

As discussed above, if the requested state save block has been located within state save files during this analysis session, the located entry within third-level index tables 914 will already store the location of the state save block. This allows the requested contents to be retrieved from state save files 230 without conducting a search. This information is then loaded into software cache 901 in the manner described above.

In some cases, when a virtual address is provided to tag logic 903 for use in retrieving contents of a state save block, that block is not resident in the software cache 901. Moreover, the cache block that corresponds to this state save information, as determined by the tag logic hashing function, is already full. In this case, one implementation of tag logic 903 uses an aging algorithm to determine which state save block will be aged from the selected cache block to make room for the newly-requested data. The requested data is retrieved from state save files 230 in one of the ways discussed above and stored in place of the state save data that was aged out of cache.

In the foregoing manner, the first-, second-, and third-level index tables are used to record the location of blocks of state save data within state save files 230. These tables may be created as follows. The first-level index table 902 may be created during initialization of SAP 804 and PAR 808. Second-level and third-level index tables 908 and 914 may be dynamically created as needed. For instance, assume that address portion 904 references an entry within first-level index table 902 that contains a null pointer. As a result, PAR 808 requests new memory banks for use in storing another second-level index table, as well as another third-level index table. These banks are allocated to the SAP 804 by analysis system 234.

Next, the bank address of the second-level index table is stored in the selected entry of the first-level index table. The entry in the second-level index table selected by address portion 910 is initialized to store the bank address of the newly-allocated third-level index table. After a search of the state save files 230, the entry in the third-level index table that is selected by address portion 916 is initialized to point to a location within the state save files. This location stores the state save block that has as its start address the virtual address determined by concatenation of address portions 904, 910, and 916.

The above-described analysis system is adapted for use with the type of target system shown in FIG. 2 that includes a legacy OS that operates primarily in virtual address space. The analysis system is adapted to use virtual, rather than physical, addresses to retrieve data from the state save files unlike other similar analysis tools that operate in physical address space. The analysis system is adapted to use those virtual addresses to reconstruct the operating environment within simulation memory on behalf of the user.

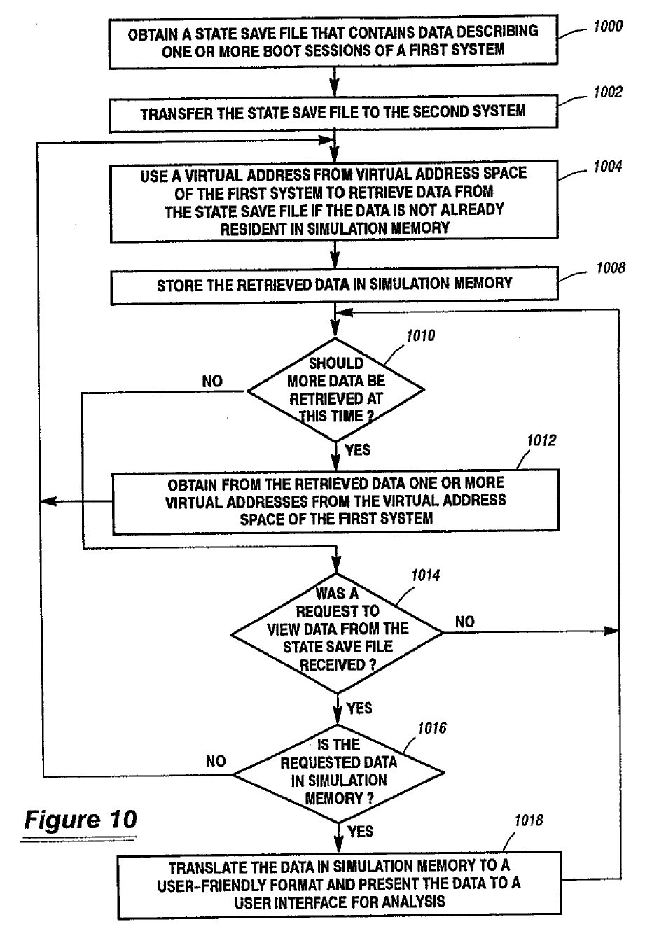

FIG. 10 is a flow diagram of a state save analysis process according to the current invention. The embodiment of FIG. 10 assumes that some state save data is reconstructed in simulation memory before the system begins receiving requests from a user and/or from SAP functions 810.

According to the method of FIG. 10, a state save file is obtained that contains data describing one or more boot sessions that occurred on a first system (1000). This state save file is transferred to a second system, which is analysis system 234 of the current invention (1002).

Next, a virtual address from the virtual address space of the first system is obtained. For instance, this may be a known virtual address at which an RBA will be located. Assuming that the data at this virtual address is not already resident in simulation memory of the analysis system, as will be the case immediately after the state save file has just been transferred to the analysis system, the virtual address is used to retrieve the requested data from the state save file (1004).

Assuming the data was not already resident in simulation memory and was therefore retrieved from the state save file, the retrieved data may then be stored in simulation memory (1008). If more data is to be retrieved at this time using a virtual address obtained from data already stored in simulation memory (1010), a virtual address may be retrieved from the data already stored within simulation memory (1012). For instance, addresses of the system level BDT 304 or DLT 306 may be obtained from the RBA that has now been stored in simulation memory 806. Processing then returns to step 1004, where the obtained virtual address is employed to retrieve data from the state save file if that data is not already resident in simulation memory.

Whether more data is to be retrieved in step 1010 may depend on implementation. For instance, the system may be configured to retrieve certain state save data such as the RBA and other memory map data from the execution environment. Then the user is allowed to begin issuing requests specifying the data he or she wants to view. In another configuration, more data (e.g., session data for one session) may be constructed in simulation memory before the system begins receiving requests from a user.

In step 1010, if it is unnecessary to retrieve more data at this time using the addresses contained in previously-retrieved data, processing proceeds to step 1014. There, it is determine whether a user request was received to view state save data. Such a request may be presented via user interfaces 812, for example. If a request is received, it is determined whether the requested data is already in simulation memory (1016). If so, the data is retrieved from simulation memory and is provided in a “user-friendly” format via one of the user interfaces (1018). This may involve providing a printout to a printer or other device so that a “hard” copy of the data is obtained. Alternatively, this may involve sending the data to a screen display, or providing the data in electronic format to another output device such as a disk burner or the like. Then processing continues to step 1010, where it is determined whether more data is to be retrieved at this time.

If, in step 1016, the data is not in simulation memory, processing proceeds to step 1004 where a virtual address from the request may be used to retrieve the requested data from the state save file. This retrieved data is stored within simulation memory, and when decision step 1014 is again encountered, the data will be available for retrieval from simulation memory.

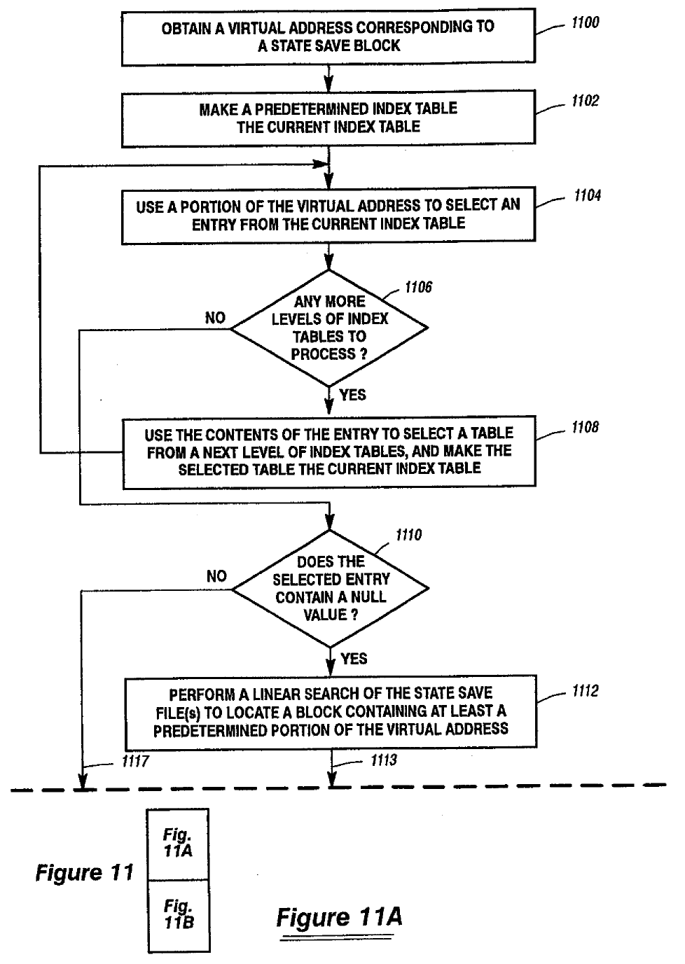

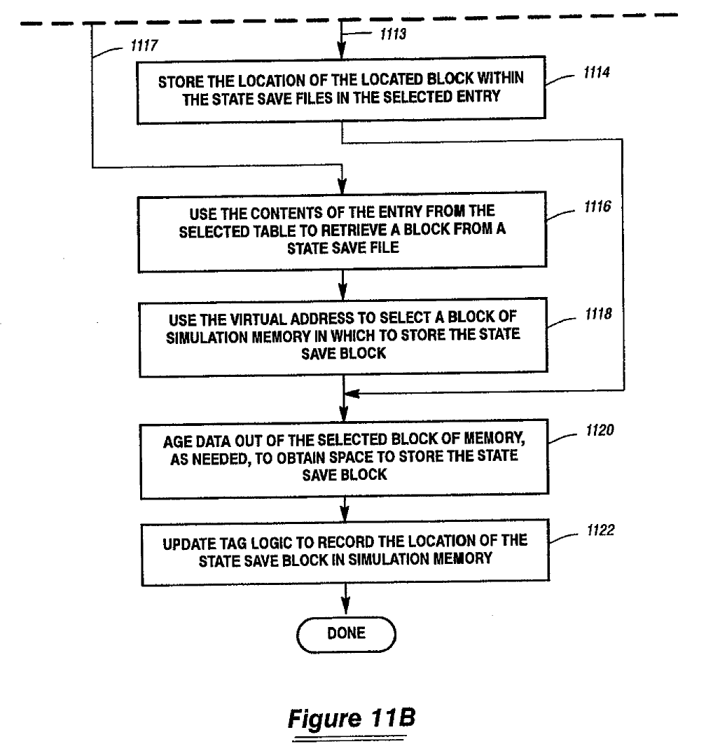

The method of FIG. 10 describes the overall process of retrieving state save data for presentation to a user. FIG. 10 does not describe the specific techniques used to record the location of data within the state save files and in simulation memory. This is illustrated further in reference to FIG. 11.

FIGS. 11A and 11B, when arranged as shown in FIG. 11, are a flow diagram illustrating a method of managing state save data as it is retrieved from the state save files and stored in simulation memory. First, a virtual address corresponding to a state save block is obtained (1100). This virtual address may be retrieved from state save data already stored in simulation memory, or from a user request.

Next, a predetermined index table is made the current index table for purposes of initiating a search (1102). In the embodiment of FIG. 9, the predetermined index table is the first-level index table 902. A portion of the virtual address is used to select an entry from the current index table (1104). If more levels of index tables remain to be processed (1106), the contents of the entry are then used to select a table from a next level of index tables (1108). Thus, for instance, the contents of a selected entry from the first-level index table are used to select an entry for the second-level index table. Processing then returns to step 1104 and the process is repeated. These steps may be repeated any number of times. That is, even though the embodiment of FIG. 9 illustrates only three levels of index tables, more may be employed if desired.

If, in step 1106 no more index table levels remain to be processed, execution continues with step 1110, where it is determined whether the selected entry contains a null value. If so, the virtual address being used to perform the search was not previously used to retrieve a block from state save files 230. Therefore, a linear search of the state save file(s) is performed to locate a block containing at least a predetermined portion of the virtual address (1112).

Processing continues to FIG. 11B, as indicated by arrow 1113. There, when the block is located, the location of the block within the state save files is stored in the selected entry (1114).

Returning to step 1110 of FIG. 11A, if the selected entry does not contain a null value, processing continues to step 1116 of FIG. 11B, as illustrated by arrow 1117. There, the contents of the entry from the selected table are employed to retrieve a block from a state save file.

In either of the cases described above, the virtual address is next used to select a block of simulation memory in which to store the state save block (1118). In one embodiment, simulation memory is implemented as a software cache, and a hash function is applied to the virtual address to select the block in simulation memory in which to store the state save block. Any hash function known in the art may be selected for this purpose.

Next, if needed, data is aged out of the selected block of simulation memory to obtain space to store the newly-acquired state save block (1120). The tag logic associated with the software cache is updated to record the location of the state save block in simulation memory (1122).

It will be understood that the above-described methods are exemplary only. In many cases, steps may be re-ordered or omitted entirely within the scope of the current invention. Steps may also be added in other embodiments.

The state save techniques described herein support the analysis of several types of state save files, including first state save files 230 that are created by a first OS, which in one embodiment is a legacy OS. The state save files further include second state save files 250 that are created by SCS 204 on behalf of the first OS. As discussed above, these second state save files are created if the system fails before the first OS has established its operating environment for a current boot session. The state save data available for analysis further includes portions of a third type of state save files 252. This third type of files is created by a second OS, which may be a commodity OS, and is recovered by the first OS for inclusion in state save files 230. Thus, analysis system 234 provides a tool that can utilize many forms of data to reconstruct an execution environment of a failed system.

As discussed above, the state save system and method support a mechanism that allows blocks of state save data to be stored in an order that is not based on the data's virtual addresses. This decreases the amount of time required to create the state save files. Paging tables are used to record the location of data within the state save files so that once a virtual address is retrieved once from the state save file, the same data may be efficiently retrieved again in the future should that data be aged from a cache of the analysis system, such as software cache 901. Virtual or physical addresses may then be employed to retrieve state save data from simulation memory 806. This is in contrast to prior art simulation environments that operate solely using physical addresses. Finally, the SAP functions 810 allow the data to be displayed in user-friendly formats so that an execution environment of one or more boot sessions may be efficiently analyzed.

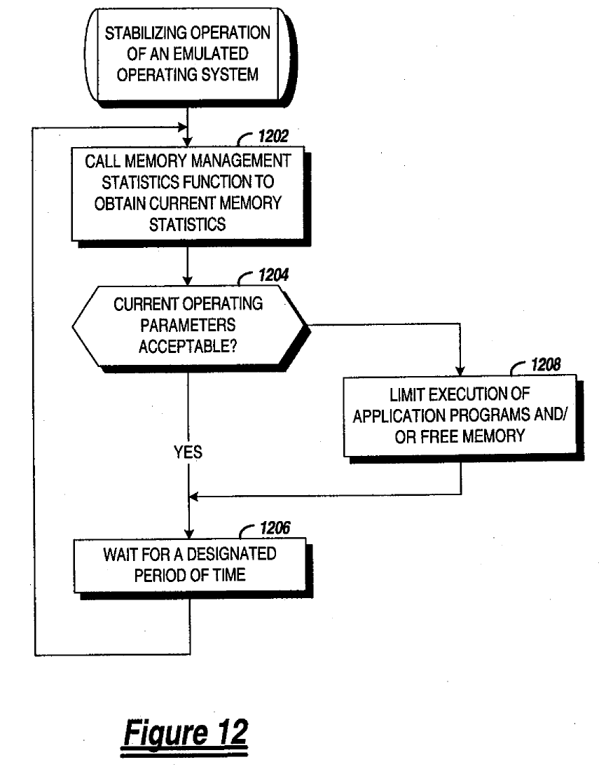

FIG. 12 is a flowchart of an example process for stabilizing operation of an emulated operating system (OS) in accordance with one embodiment of the invention. Whereas in conventional systems, with or without emulation, it might be expected that the host OS would monitor memory statistics and take precautionary measures in order to stabilize operations, the present invention takes the opposite approach. That is, the emulated OS monitors the host OS since the host OS may be insufficiently stable due to less aggressive control by the host OS over memory usage.

The process of FIG. 12 generally entails the emulated OS monitoring the memory usage of the host OS and taking precautionary measures to stabilize operation when the memory usage reaches certain thresholds. The process has the emulated OS polling or periodically requesting the host OS for its memory usage statistics. These memory usage statistics are examined and appropriate actions taken.

At step 1202, the emulated OS calls the memory management statistics function to obtain current memory statistics from the host OS. Decision step 1204 tests whether the current operating parameters are within acceptable thresholds. Two example operating parameters are the amount of free memory and amount of free swap space.

If the current operating parameters are acceptable, at step 1206 the emulated OS waits for a designated period of time before returning to step 1202 to again obtain the memory usage statistics. In general the waiting period is either a constant or the period of time that it would take for the system to stabilize enough to warrant taking another sample.

If the current operating parameters are not acceptable, at step 1208 the emulated OS limits execution of application programs and/or frees memory allocated by the host OS to the emulated OS. The particular action taken by the emulated OS depends on the severity of the condition. For example, the actions may range from preventing further applications from starting to terminating one or more running applications.

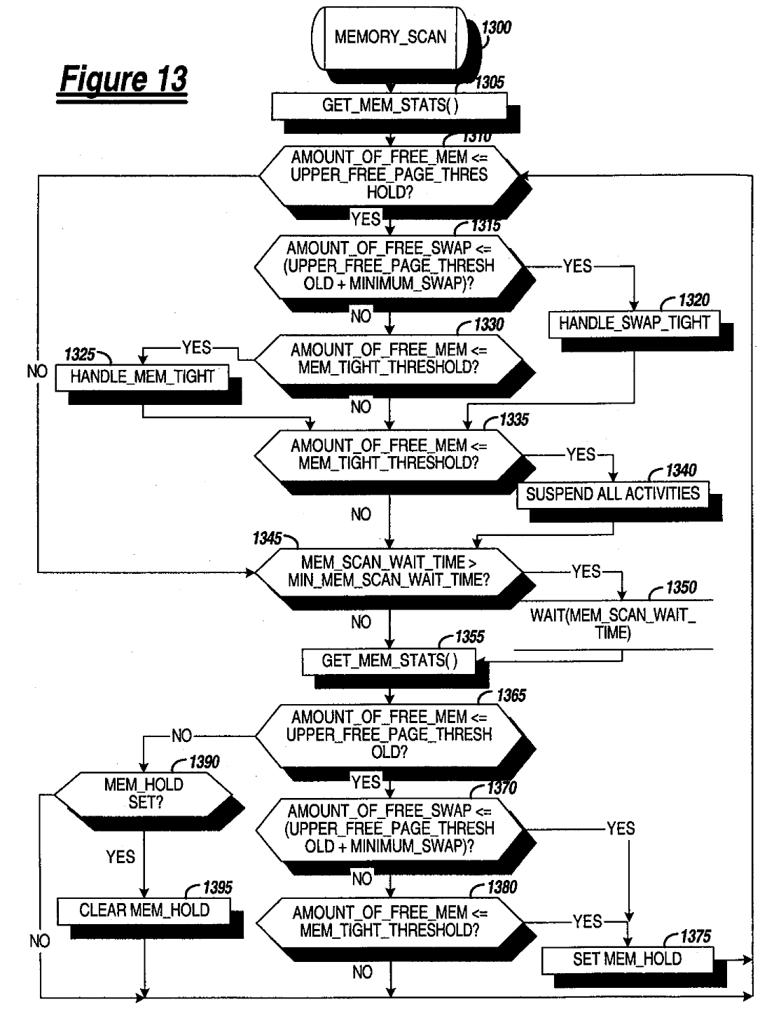

FIGS. 13, 14, and 15 illustrate example routines of the emulated OS that implement algorithms for polling the host OS for memory statistics, controlling and limiting execution of application programs running under the emulated OS, and controlling memory allocation to the emulated OS. Those skilled in the art will recognize various equivalent alternatives to the illustrated algorithms.

FIG. 13 is a flowchart of an example process for periodically obtaining memory usage statistics of the host OS by the emulated OS and adjusting memory usage of the emulated operating system. The process of FIG. 13 relies on memory statistics related to available memory, free memory, and swap space.

Available memory is memory that can be allocated by the host OS for use by the host OS, to the emulated OS, or to any other program running under host OS.

Freeing memory returns available memory space from the emulated. OS to the host OS. Once memory is freed, that memory may not be used by the emulated OS to allocate to applications running under the emulated OS. The freed memory is available to the host OS for its use.

Swap space refers to auxiliary storage space, for example, a magnetic disk, reserved by the host operating system for moving pages/segments/blocks of data (or instructions) between the memory and the auxiliary storage system to allow for fast access to portions of a data set that may not fit into memory in its entirety.

When activated the memory_scan routine 1300 fetches the current memory statistics by calling get_mem_stats at step 1305. The get_mem_stats routine calls on the host OS to provide the memory statistics information. The statistics listed below in Table 11 are returned by the host OS and the threshold variables in Table 12 are calculated.

TABLE 11

| Statpkt | Description |
|---|---|
| Physical_processors | The number of physical core processors is used to determine |
| | the memory tight and critical thresholds and the amount of time |
| | to wait between executions of the memory scan code. |
| Scaling_units | Used to convert values from the units returned to the units used |
| | by the emulated system. |
| Free_physical_memory | Used to decide whether to put a “hold” on the system (if the |
| | amount of free memory is less than the memory tight threshold a |
| | hold is placed on the system) and used to determine the amount |
| | of time to wait between executions of the memory scan code. |
| Max_swap_space | Diagnostics only |
| Free_swap_space | Used to determine whether to put a “hold” on the system (if the |
| | amount of free swap is less than the memory tight threshold plus |
| | some constant). Used to determine if more serious action needs to |
| | be taken (if the amount of free swap is less then the memory critical |
| | threshold plus some constant. |

The threshold variables in Table 12 are calculated by the Get_Mem_Stats routine and are used in changing the memory usage by the emulated OS.

TABLE 12

| | |
|---|---|
| Min_free_page_count = | Constant |
| Min_swap = | Constant |
| Mem_tight_page_count = | Constant |
| Mem_critical_page_count = | Constant |
| Min_mem_scan_wait_time = | Constant |
| Max_mem_scan_wait_time = | Constant |
| Upper_free_page_threshold = | Statpkt.physical_processors * |
| | min_free_page_count |
| Mem_tight_threshold = | Statpkt.physical_processors * |
| | mem_tight_page_count |
| Mem_critical_threshold = | Statpkt.physical_processors * |
| | mem_critical_page_count |
| Amount_of_free_mem = | Statpkt.free_physical_memory |
| Amount_of_free_swap = | Statpkt.free_swap_space |
| Num_of_free_pages = | Statpkt.free_physical_memory/8 |
| Mem_scan_wait_time = | MIN(((MAX((num_of_free_pages − |
| | mem_critical_threshold),0)/16)/ |
| | statpkt.physical_processors), |
| | max_mem_scan_wait_time) |

The constants are specific to the operation of the emulated operating system. The constants may vary from one operating system to the next. In an example embodiment the constants are generally defined as follows:
Min_free_page_count is the minimum number of free memory pages that the operating system needs to operate effectively.
Min_swap is the minimum number of swap pages that the operating system needs to operate effectively.
Mem_tight_page_count is the number of free memory pages available that would begin to make the operating system struggle.
Mem_critical_page_count is the number of free memory pages available that would begin to make the operating system really struggle.
Min_mem_scam_wait_time is the minimum number of milleseconds to wait before reading the memory statistics.
Max_mem_scan_wait_time is the maximumber number of milleconds to wait before reading the memory statistics.

Mem_scan_wait_time is used to control the time (e.g., in milliseconds) to wait before again reading the memory statistics. The difference between the current number of free pages and the memory critical threshold is calculated. If that value is negative, 0 is substituted. That value is divided by 16, since in an example implementation an IP can zero out at most 16 pages in a millisecond, which is independent of the speed of a CPU and dependent upon the speed of memory. The result, divided by the number of physical processors, is the amount of time it would take to drive the number of free pages down to the memory_critical_threshold, assuming all CPUs were consuming free pages as fast as possible.

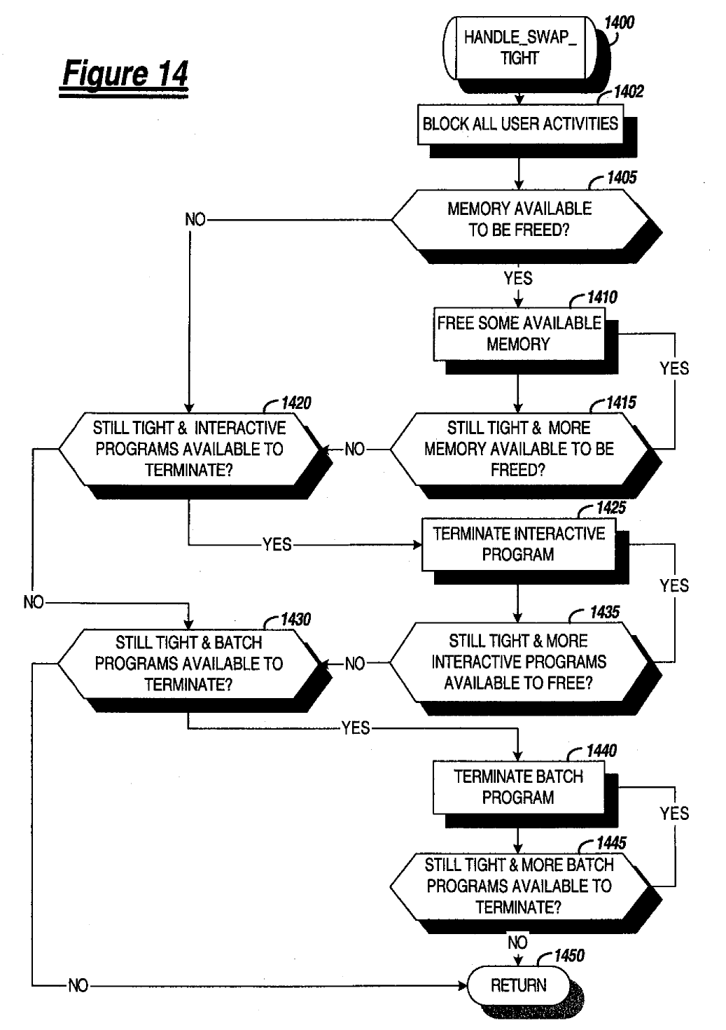

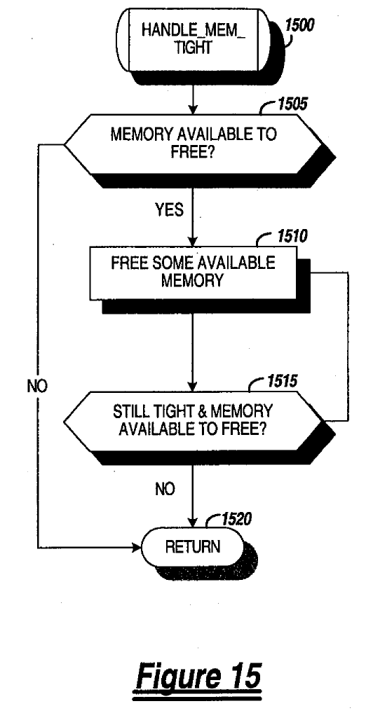

At decision step 1310, the routine compares amount_of_free_mem to the threshold variable upper_free_page_threshold. If the amount_of_free_mem is less than or equal to the upper_free_page_threshold, the routine at decision step 1315 determines whether the amount of free_swap is less than or equal to (upper_free_page_threshold +min_swap). If the test of decision step 1315 is positive, the routine invokes the handle_swap_tight routine (show in FIG. 14) at step 1320. Otherwise, decision step 1330 tests whether amount_of_free_mem is less than or equal to the mem_tight_threshold. The handle_mem_tight routine (shown in FIG. 15) is invoked at step 1325 if the test of decision step 1330 is positive. Otherwise, the routine proceeds directly to decision step 1335.

At decision step 1335, the routine tests whether the amount_of_free_mem is less than or equal to the mem_tight_threshold. If so, the routine suspends all activities for N microseconds at step 1340 and then proceeds to decision step 1345. In an example embodiment N is based on the mem_tight_threshold, mem_critical_threshold, and num_of_free_pages. Specifically, N may be set as follows:
A=−48000/(mem_tight_threshold−((mem_tight_threshold−mem_critical_threshold)/2))
B=50000−A*mem_critical_threshold
C=A*num_of_free_pages+B

At decision step 1345, the routine tests whether mem_scan_wait_time is greater than the min_mem_scan_wait_time. If so, the routine waits for the period specified by mem_scan_wait_time at step 1350. The routine then proceeds to step 1355 where the get_mem_stats routine is called again.

Decision step 1365 tests whether the amount_of_free_mem is less than or equal to the upper_free_page_threshold. If so, the routine proceeds to also check whether the amount_of_free_swap is less than or equal to the (upper_free_page_threshold+minimum_swap) at decision step 1370. The mem_hold variable is set at step 1375 if the condition at decision step 1370 tests true. When the mem_hold variable is set the emulated OS will not allow new processes or programs to begin executing. When the mem_hold variable is clear, the emulated OS allows new processes or programs to begin executing. After setting the mem_hold variable, the routine returns to decision step 1310 to repeat the loop of testing threshold variables and taking appropriate actions.

If the condition at decision step 1370 tests not true, at decision step 1380 the routine tests whether the amount_of_free_mem is less than or equal to the mem_tight_threshold. If so, the routine sets the mem_hold variable at step 1375 as described above. Otherwise, the routine returns to decision step 1310.

Returning to decision step 1365, if the decision step finds that the amount_of_free_mem is greater than the upper_free_page_threshold, the routine checks whether mem_hold is set at decision step 1390. If mem_hold is set, step 1395 clears mem_hold and the routine returns to decision step 1310. If mem_hold is cleared, the routine simply returns to decision step 1310.

FIG. 14 is a flowchart of an example process for adjusting memory usage by the emulated operating system in response to the amount of free swap space being less than a threshold amount. The process is implemented as the handle_swap_tight 1400 routine, which generally frees memory and terminates as many programs or processes as needed to relieve the swap tight condition.

At step 1402, the routine blocks all user activities are blocked. To perform this task the routine first suspends all other emulated IPs in the system by putting the emulated IPs into a tight loop, which is exited upon receipt of a signal from the emulated IP performing the handle swap tight routine. The tight loop inspects the contents of a global memory cell and repeats the checking until the contents of that memory cell are equal to a value that signals the loop is to terminate.

Next, in blocking all user activities, the hand_swap_tight routine creates high priority emulated OS activities. The activities may be threads that execute instructions whose only purpose is to consume emulated IP cycles. Once these high-priority activities are running, the global memory cell is set to the value that allows the emulated IPs to exit their tight loops. The high priority OS activities should use up almost all of the emulated IP cycles doing nothing, while still allowing the emulated IPs to service interrupts and not time out.

Part of blocking all user activities also includes suspending all user (non-OS) activities, other than batch activities, that are not running with the OS key. User activities that are running with the OS key are set to trap when they exit the OS, and are then blocked. The OS key means that the code in the emulated operating system (kernel) is being executed. User threads that are running in the OS, executing OS code, run with the OS key. User threads that are not running in the OS, executing user code, execute with the key associated with the user.

Once the user activities have been suspended, the high priority OS activities are terminated. This leaves the system in a state in which all emulated OS work can continue and all user activities are either blocked or will become blocked when they exit the OS.

Decision step 1405 tests whether memory is available to be freed. If so, the routine frees some of the memory at step 1410 by calling on routines of the host OS. Some of the applications running in the system may have pools of memory assigned to them for performance reasons. Temporarily reducing this memory will not terminate those applications. The emulated OS scans the applications and attempts to free some of this non-critical memory. A small amount memory is freed until the memory thresholds are more favorable. Freeing all the memory at once is generally undesirable. Thus, a suitable quantity of memory is freed, and if the memory thresholds are still tight or critical the process may proceed and take additional steps.

The routine then checks whether memory usage is still tight and there is more memory available to be freed at decision step 1415. If so, the routine returns to step 1420 to free additional memory. Still tight in the decision steps of FIG. 14 refers to the amount_of_free_mem being less than or equal to the mem_tight_threshold as described in FIG. 13.

If there is no available memory to be freed as determined at decision step 1405 or 1415, the routine checks whether memory usage conditions are still tight and there are interactive programs which can be terminated at decision step 1420. If so, the routine selects and terminates an interactive program at step 1425. In an example implementation, the lowest priority program that is using the largest amount of memory may be selected for termination.

The routine then proceeds to decision step 1435, which checks whether memory usage is still tight and there are more interactive programs to terminate. If so, the routine returns to step 1425 to terminate another interactive program. If memory usage is still tight and there are no more interactive programs to terminate (or memory usage is not tight), the routine checks whether memory is still tight and there are batch programs available to terminate at decision step 1440. If so, the routine selects and terminates a batch program at step 1450. Decision step 1455 then checks whether memory usage is still tight and there are more batch programs available to terminate. The routine returns to step 1450 to terminate an additional batch program if so. Otherwise, the routine returns at step 1460 to the memory_scan routine of FIG. 13.

FIG. 15 is a flowchart of an example process for adjusting memory usage by the emulated operating system in response to the amount of free memory being available to the emulated operating system being less than a threshold amount. The process is implemented as the handle_mem_tight routine which is called from the memory_scan routine of FIG. 13. The handle_mem_tight 1500 routine generally performs minor actions that may help the tight memory situation.

Decision step 1505 tests whether there is still memory available to free. If so, step 1510 deletes an inactive transaction, whereby the amount of memory used by that transaction is freed. In an example implementation, a transaction is a unit of execution in a transaction processing system for interacting with a transaction database.

If memory is still tight and there is memory available to free, decision step 1515 returns the routine to step 1510 to free some additional available memory. Once there is no more memory available to be freed or the memory tight condition has passed, the routine returns control to the memory_scan routine at step 1520.

Those skilled in the art will appreciate that various alternative computing arrangements, including one or more processors and a memory arrangement configured with program code, would be suitable for hosting the processes and data structures of the different embodiments of the present invention. In addition, the processes may be provided via a variety of computer-readable storage media or delivery channels such as magnetic or optical disks or tapes, electronic storage devices, or as application services over a network.

The present invention is thought to be applicable to a variety of software systems. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A method for stabilizing an emulated system, comprising:
executing a first operating system (OS) on an instruction processor of a data processing system, wherein the first OS includes instructions of a first instruction set that are native to the instruction processor;
emulating a second OS and a plurality of application programs on the first OS on the data processing system, wherein the second OS and application programs include instructions of a second instruction set that are not native to the instruction processor;
polling the first OS by the emulated second OS for memory statistics, wherein the memory statistics indicate a current state of operating parameters of the memory of the data processing system used by the first OS in managing the data processing system; and
controlling a number of the application programs allowed to execute by the second OS in response to the memory statistics provided by the first OS to the second OS.

2. The method of claim 1, wherein the controlling includes denying initiation of execution of an additional application program beyond currently executing ones of the plurality of application programs.

3. The method of claim 1, wherein the controlling includes terminating execution of one or more of currently executing ones of the plurality of application programs.

4. The method of claim 3, wherein the terminated one or more application programs is an interactive program, the method further comprising:
after the terminating step, requesting by the emulated second OS to the first OS for the first OS to provide the memory statistics, and determining by the second OS whether the current state of operating parameters indicated by the memory statistics is acceptable or unacceptable; and
in response to the current state of the operating parameters being unacceptable, repeating the terminating and requesting steps until the current state of the operating parameters is acceptable.

5. The method of claim 4, wherein the terminating and requesting steps are repeated until there is no interactive program available to terminate.

6. The method of claim 5, wherein at least one currently executing application program is a batch program, the method further comprising:
in response to the current state of the operating parameters being unacceptable and there being no interactive program available to terminate, the terminating step terminates execution of at least one currently executing batch program.

7. The method of claim 3, wherein the plurality of application programs include interactive programs and batch programs, wherein the terminating includes selecting interactive programs for termination before selecting batch programs for termination.

8. The method of claim 1, further comprising:
determining by the second OS whether the current state of operating parameters indicated by the memory statistics is acceptable or unacceptable; and
wherein the controlling includes,
denying initiation of execution of an additional application program beyond currently executing ones of the plurality of application programs in response to the current state being unacceptable, and
allowing initiation of execution of an additional application program beyond currently executing ones of the plurality of application programs in response to the current state being acceptable.

9. The method of claim 1, further comprising:
determining by the second OS whether the current state of operating parameters indicated by the memory statistics is acceptable or unacceptable; and
in response to the current state being unacceptable, returning by the second OS to the first OS, memory that is allocated to the second OS and that the second OS has not allocated to any of the plurality of application programs.

10. An emulation system, comprising:
a data processing system including at least one instruction processor coupled to a memory;
a first operating system (OS) executing on the at least one instruction processor, wherein the first OS includes instructions of a first instruction set that are native to the instruction processor;
means for emulating a second OS and a plurality of application programs on the first OS, wherein the second OS and application programs include instructions of a second instruction set that are not native to the instruction processor;
means for periodically requesting by the emulated second OS for memory statistics from the first OS, wherein the memory statistics indicate a current state of operating parameters of the memory of the data processing system used by the first OS in managing the data processing system; and
means for limiting execution of the application programs by the second OS in response to the memory statistics provided by the first OS to the second OS.

11. An emulation system, comprising:
a data processing system including at least one instruction processor coupled to a memory, and a first operating system (OS) executing on the at least one instruction processor, wherein the first OS includes instructions of a first instruction set that are native to the instruction processor;
an instruction processor emulator executable on the at least one instruction processor, wherein the instruction processor emulator emulates execution of instructions of a second instruction set that are not native to the at least one instruction processor;
a second OS and a plurality of application programs emulated on the instruction processor emulator, wherein the second OS and application programs include instructions of a second instruction set that are not native to the instruction processor;
wherein the second OS executes program code that performs the steps including,
periodically requesting memory statistics from the first OS, wherein the memory statistics indicate a current state of operating parameters of the memory of the data processing system used by the first OS in managing the data processing system;
determining whether the current state of operating parameters indicated by the memory statistics is acceptable or unacceptable;
selecting, in response to the current state being unacceptable, between terminating one or more of the plurality of application programs and returning to the first OS memory that is allocated to the second OS; and
performing the selected one of terminating one or more application programs and freeing memory.

12. The emulation system of claim 1, wherein the selecting includes selecting between denying initiation of execution of an additional application program beyond currently executing ones of the plurality of application programs, terminating one or more of the plurality of application programs and returning to the first OS memory that is allocated to the second OS.

13. The emulation system of claim 12, wherein the terminated one or more application programs is an interactive program, the steps further including,
after the terminating step, requesting by the emulated second OS to the first OS for the first OS to provide the memory statistics, and determining by the second OS whether the current state of operating parameters indicated by the memory statistics is acceptable or unacceptable; and
in response to the current state of the operating parameters being unacceptable, repeating the terminating and requesting steps until the current state of the operating parameters is acceptable.

14. The emulation system of claim 13, wherein the terminating and requesting steps are repeated until there is no interactive program available to terminate.

15. The emulation system of claim 14, wherein at least one currently executing application program is a batch program, the steps further including, in response to the current state of the operating parameters being unacceptable and there being no interactive program available to terminate, the terminating step terminates execution of at least one currently executing batch program.

16. The emulation system of claim 12, wherein the plurality of application programs include interactive programs and batch programs, wherein the terminating includes selecting interactive programs for termination before selecting batch programs for termination.

17. The emulation system of claim 11, the steps further including,
determining by the second OS whether the current state of operating parameters indicated by the memory statistics is acceptable or unacceptable;
denying initiation of execution of an additional application program beyond currently executing ones of the plurality of application programs in response to the current state being unacceptable, and
allowing initiation of execution of an additional application program beyond currently executing ones of the plurality of application programs in response to the current state being acceptable.

18. The emulation system of claim 11, the steps further including,
determining by the second OS whether the current state of operating parameters indicated by the memory statistics is acceptable or unacceptable, and
in response to the current state being unacceptable, returning by the second OS to the first OS, memory that is allocated to the second OS and that the second OS has not allocated to any of the plurality of application programs.

19. The emulation system of claim 11, wherein the terminated one or more application programs is an interactive program, the steps further including,
after the terminating step, requesting by the emulated second OS to the first OS for the first OS to provide the memory statistics, and determining by the second OS whether the current state of operating parameters indicated by the memory statistics is acceptable or unacceptable, and
in response to the current state of the operating parameters being unacceptable, repeating the terminating and requesting steps until the current state of the operating parameters is acceptable.

20. The emulation system of claim 19, wherein the terminating and requesting steps are repeated until there is no interactive program available to terminate.
